(19) United States
(12) Patent Application Publication
(10) Pub. No.: US 2023/0125125 A1
(43) Pub. Date: Apr. 27, 2023

(54) BIODEGRADABLE PLASTIC COMPOSITE CONTAINING FIBERS

(71) Applicant: TERRAMER, INC., Inglewood, CA (US)

(72) Inventors: Alex MOND, Sherman Oaks, CA (US); Bryan ARRAYALES, Los Angeles, CA (US)

(73) Assignee: TERRAMER, INC., Inglewood, CA (US)

(21) Appl. No.: 17/972,001

(22) Filed: Oct. 24, 2022

Related U.S. Application Data
(60) Provisional application No. 63/271,978, filed on Oct. 26, 2021.

(51) Int. Cl. C08L 67/02

(52) U.S. Cl. CPC C08L 67/02; C08L 2207/02; C08L 2205/16; C08L 2205/03; C08L 2201/06

(57) ABSTRACT

A biodegradable composite may include a biodegradable plastic polymer having a biodegradability of from about 80 percent (%) to about 95% when measured according to a biodegradability test in accordance with an ASTM D6400-19 standard and a bio-derived fiber. A polymeric matrix of the biodegradable plastic polymer may have a tensile strength of from about 30 MPa to about 45 MPa and an elastic modulus of from about 2600 MPa to about 3600 MPa. The bio-derived fiber may have a tensile strength greater than the tensile strength of the polymeric matrix of the biodegradable plastic polymer and an elastic modulus greater than the elastic modulus of the polymeric matrix.

### CROSS-REFERENCE TO RELATED APPLICATIONS

This application is based upon and claims the benefit under 35 USC 119(e) of prior U.S. Provisional Patent Application No. 63/271,978, filed Oct. 26, 2021, in the U.S. Patent and Trademark Office, the entire contents of all of which is incorporated herein by reference.

### BACKGROUND

Organic polymers have been used as ingredients for different types of plastics and their composites. Their plasticity enables plastics to be used to produce objects of various shapes, using techniques such as molding, extruding or pressing. Organic polymers and their plastics have been used widely due to their plasticity, adaptability, relatively lower costs of productions and a variety of properties, such as relatively lightweight, durability, flexibility, and moldability. Most commonly used organic polymers and plastics are derived from fossil fuel-based chemicals including natural gas or petroleum. However, due to their dependencies on fossil fuels, slow decomposition rates in the natural ecosystem, and toxic byproduct generations during the manufacturing processes or disintegration processes, some of the commonly used plastics are considered to cause environmental problems.

### DETAILED DESCRIPTION

Reference will now be made in detail to examples. The disclosure according to an example may be variously modified to various other examples. In this disclosure, when it is stated that one constituent element is “connected to” another constituent element, it includes a case in which the two constituent elements are connected to each other with another constituent element intervened therebetween as well as a case in which the two constituent elements are directly connected to each other. As used herein, the term “and/or” associated with listed items indicates inclusions of any and all possible combinations of one or more of the associated listed items. Expressions such as “at least one of,” when preceding a list of elements, modify the entire list of elements and do not modify the individual elements of the list. Terms used in the specification, “first”, “second”, etc. may be used to describe various components, but the components are not to be interpreted to be limited to the terms, as these terms are only used to differentiate one component from other components. In this disclosure, “a” or “an” refers to “one or more”, unless a modifier is used such as “a single.” “A” or “an” are common terms of art that are referring to “one or more”. For example “a polymer type” means one or more polymer types and “a first polymer type” means one polymer type and “a second polymer type” means one polymer type. For example, “An aspect” means one or more aspects. The aforementioned is the general format that should be applied to other such terms throughout the disclosure.

The plastics industry is implementing, for some applications, organic polymers or plastics that are more readily degradable in the environment, such as bioplastics and biodegradable plastics. To address problems associated with fossil fuel-derived polymers and/or plastics, plastics and organic polymers that are biodegradable and/or derived from biodegradable and/or renewable materials, such as corn, may be introduced. Bio-source and biodegradable plastics and polymers may be developed, with its objective to replace non-biodegradable or relatively less biodegradable plastic with renewal and compostable material, and replacing a stream of toxic plastic waste pollution.

Bioplastics or biodegradable plastics may have come in the form of high production costs, when compared to petroleum-based plastics, which prolongs the process of replacing petroleum plastics with bioplastics or biodegradable plastics. Accordingly, there is also a demand to bring down the cost of producing such biodegradable plastics such that a product based on biodegradable plastics can be priced competitively when compared to a product based on common plastics, petroleum-based plastics or non-biodegradable plastics. Bioplastics or biodegradable plastics may also have come in the form of relatively weaker mechanical properties compared to petroleum-based plastics, which prolongs the process of replacing petroleum plastics with bioplastics or biodegradable plastics.

According to an example, an application of a biodegradable composite may include the composite including degradable fibers as reinforcement agents in semi-degradable or petroleum plastics. For example, a degradable fiber may be used as a reinforcing filler for an application such as a material for an aircraft, automotive and construction. A degradable fiber may be used as an alternative to a synthetic fiber as a reinforcement agent in plastics because of, for example, low cost, low density, a good mechanical property and/or a degradable property. For example, an application in the automotive industry may include a material for a door panel, a seat back, a dashboard and a package tray, a head restraint and a seatback lining. An application in the automotive space may include a fiber reinforced polylactic acid or polylactide (“PLA”) composite; PLA is considered as a semi-degradable polymer as a neat resin. For example, a jute fiber, kenaf fiber or a pineapple fiber may be used for a composite and can be applied for a component such as a door panel or a body of a vehicle. For example, 35% Baypreg F semi-rigid (PUR) elastomer 65% of a blend of flax, hemp and sisal may be blended for a composite.

There may have been little availability of composites made out of a degradable or biodegradable fiber and/or degradable or biodegradable neat resins. One of the drawbacks to using degradable or biodegradable fibers in a commercial plastic product, such as a container c a cup, a bottle and other packing materials, is the moisture sensitivity of the degradable fibers. Therefore, According to an example, it may be on how to decrease water sensitivity while maintaining the mechanical properties provided by the degradable fibers.

This disclosure discloses, according to an example, a biodegradable plastic composite and its application, such as a container, such as a cup.

According to an example, the term plastic may means a material that contains as an essential ingredient one or more organic polymeric substances of large molecular weight, is solid in its finished state, and, at some stage in its manufacture or processing into finished articles, can be shaped by flow. However, ordinary meaning(s) of the term plastic that would be as understood by those skilled in the art is implemented in this disclosure.

According to an example, the term polymer may mean a substance comprising molecules characterized by the repetition (neglecting ends, branch junctions, other minor irregularities) of one or more types of monomeric units. However, ordinary meaning(s) of the term polymer that would be as understood by those skilled in the art is implemented in this disclosure.

According to an example, a container may comprise a biodegradable composite forming at least a portion of the container. The biodegradable composite may include a biodegradable plastic polymer having a biodegradability of from about 80 percent (%) to about 95 percent (%) when measured according to the standard by American Society for Testing and Materials—ASTM D6400, biodegradability standard—wherein a polymeric matrix of the biodegradable plastic polymer has a tensile strength of from about 30 Megapascal (MPa) to about 45 MPa and an elastic modulus of from about 2600 MPa to about 3600 MPa. According to an example, the biodegradable composite may include a biodegradable fiber having a tensile strength greater than the tensile strength of the polymeric matrix of the biodegradable plastic polymer and an elastic modulus greater than the elastic modulus of the polymeric matrix.

According to an example, a container may comprise a biodegradable composite forming at least a portion of the container. The biodegradable composite may include a biodegradable plastic polymer having a biodegradability of from about 80 percent (%) to about 95 percent (%) when measured according to an ASTM D6400-19 biodegradability standard, wherein a polymeric matrix of the biodegradable plastic polymer has a tensile strength of from about 30 MPa to about 45 MPa and an elastic modulus of from about 2600 MPa to about 3600 MPa. According to an example, the biodegradable composite may include a biodegradable fiber having a tensile strength greater than the tensile strength of the polymeric matrix of the biodegradable plastic polymer and an elastic modulus greater than the elastic modulus of the polymeric matrix.

According to an example, the biodegradable composite may have a tensile strength greater than 45 MPa.

According to an example, the biodegradable composite may have the tensile strength of from about 55 MPa to about 90 MPa.

According to an example, the biodegradable composite may have an elastic modulus greater than about 3600 MPa.

According to an example, the biodegradable plastic polymer may include at least one selected from a group comprising or consisting of poly-3-hydroxybutyrate (“P3HB”), poly-4-hydroxybutyrate (“P4HB”), poly 3-hydroxybutyrate-co-4-hydroxybutyrate (“P3HB-co-4HB”), poly-3-hydroxybutyrate-co-3-hydroxyvalerate (“PHBV”), and pPoly-3-hydroxybutyratehexanoate (“PBHH”), polylactic acid (“PLA”), thermoplastic starch (“TPS”), poly-caprolactone (“PCL”), polybutylene succinate (“PBS”) and polyvinyl alcohol (“PVA”).

According to an example, the biodegradable plastic polymer may include at least one selected from a group comprising or consisting of poly-3-hydroxybutyrate (“P3HB”), poly-4-hydroxybutyrate (“P4HB”), poly 3-hydroxybutyrate-co-4-hydroxybutyrate (“P3HB-co-4HB”), poly-3-hydroxybutyrate-co-3-hydroxyvalerate (“PHBV”), poly-3-hydroxybutyratehexanoate (“PBHH”), polylactic acid (“PLA”), thermoplastic starch (“TPS”), poly-caprolactone (“PCL”), polybutylene succinate (“PBS”), polyglycolic acid (“PGA”), poly(lactic-co-glycolic acid) (“PLGA”), polybutylene adipate terephthalate (“PBAT”) and polyvinyl alcohol (“PVA”).

According to an example, the biodegradable plastic polymer may include poly-3-hydroxybutyrate-co-3-hydroxyvalerate (“PHBV”).

According to an example, the biodegradable fiber includes at least one selected from a group consisting of flax fiber, hemp fiber, jute fiber, kenaf fiber and bamboo fiber.

According to an example, the bio-derived fiber includes at least one selected from a group comprising or consisting of flax fiber, hemp fiber, ramie fiber, jute fiber, abaca fiber, cantala fiber, henequen fiber, sisal fiber, pineapple fiber, mitsumata fiber, gampi fiber, and kozo fiber.

According to an example, the biodegradable fiber may include hemp fiber.

According to an example, the biodegradable plastic composite may include about 5 weight percent (wt. %) or more of the hemp fiber with respect to a weight of the biodegradable plastic composite and about 30 wt. % or less of the hemp fiber with respect to a weight of the biodegradable plastic composite.

According to an example, the biodegradable plastic composite includes PHBV and about 5 weight percent (wt. %) or more of the hemp fiber with respect to a weight of the biodegradable plastic composite and about 30 wt. % or less of the hemp fiber with respect to a weight of the biodegradable plastic composite.

According to an example, the biodegradable plastic composite may include wax.

According to an example, the wax may be adhered to a surface of the biodegradable fiber.

According to an example, the biodegradable plastic composite may exhibit a water contact angle equal to or greater than about 90°.

According to an example, a biodegradable composite may comprise a biodegradable plastic polymer having a biodegradability of from about 80 to 95 percent (%) within 180 days when measured according to an ASTM D6400 biodegradability standard, wherein a polymeric matrix of the biodegradable plastic polymer has a tensile strength of about 30 MPa to about 45 MPa and an elastic modulus of from about 2600 MPa to about 3600 MPa. According to an example, the biodegradable polymer may comprise a biodegradable fiber having wax on a surface of the biodegradable fiber. According to an example, the biodegradable fiber may have a density of from about 1.3 gram per cm³ (g/cm³) to about 1.5 g/cm³, a tensile strength of from about 90 MPa to about 900 MPa; and an elastic modulus of from about 4000 MPa to about 5000 MPa.

According to an example, a biodegradable composite may comprise a biodegradable plastic polymer having a biodegradability of from about 80 to 95 percent (%) within 180 days when measured according to an ASTM D6400-19 biodegradability standard, wherein a polymeric matrix of the biodegradable plastic polymer has a tensile strength of about 30 MPa to about 45 MPa and an elastic modulus of from about 2600 MPa to about 3600 MPa. According to an example, the biodegradable polymer may comprise a biodegradable fiber having wax on a surface of the biodegradable fiber. According to an example, the biodegradable fiber may have a density of from about 1.3 g/cm³ to about 1.5 g/cm³, a tensile strength of from about 90 MPa to about 900 MPa; and an elastic modulus of from about 4000 MPa to about 5000 MPa.

According to an example, the biodegradable composite may have the tensile strength of from about 55 MPa to about 90 MPa. According to an example, the biodegradable plastic composite may exhibit a water contact angle equal to or greater than about 90°.

According to an example, the biodegradable plastic polymer may include poly-3-hydroxybutyrate-co-3-hydroxyvalerate (“PHBV”). According to an example, the biodegradable fiber includes hemp fiber.

According to an example, a method of producing a biodegradable composite may comprise wetting a biodegradable fiber with wax emulsion and fusing the biodegradable fiber having the wax with a biodegradable plastic polymer having a biodegradability of from about 80 to 95 percent (%) within 180 days, when measured according to an ASTM D6400 biodegradability standard, wherein a polymeric matrix of the biodegradable plastic polymer has a tensile strength of about 30 MPa to about 45 MPa and an elastic modulus of from about 2600 MPa to about 3600 MPa, and wherein the biodegradable fiber has a tensile strength greater than the tensile strength of the polymeric matrix of the biodegradable plastic polymer and an elastic modulus greater than the elastic modulus of the polymeric matrix.

According to an example, a method of producing a biodegradable composite may comprise wetting a biodegradable fiber with wax emulsion and fusing the biodegradable fiber having the wax with a biodegradable plastic polymer having a biodegradability of from about 80 to 95 percent (%) within 180 days, when measured according to an ASTM D6400-19 biodegradability standard, wherein a polymeric matrix of the biodegradable plastic polymer has a tensile strength of about 30 MPa to about 45 MPa and an elastic modulus of from about 2600 MPa to about 3600 MPa, and wherein the biodegradable fiber has a tensile strength greater than the tensile strength of the polymeric matrix of the biodegradable plastic polymer and an elastic modulus greater than the elastic modulus of the polymeric matrix.

According to an example, a container may comprise a biodegradable composite forming at least a portion of the container. The biodegradable composite may include a biodegradable plastic polymer having a biodegradability of from about 80 percent (%) to about 95 percent (%) when measured according to an ASTM D6400 biodegradability standard, wherein a polymeric matrix of the biodegradable plastic polymer has a tensile strength of from about 30 MPa to about 45 MPa and an elastic modulus of from about 2600 MPa to about 3600 MPa. According to an example, the biodegradable composite may include a biodegradable fiber having a tensile strength greater than the tensile strength of the polymeric matrix of the biodegradable plastic polymer and an elastic modulus greater than the elastic modulus of the polymeric matrix.

According to an example, a container may comprise a biodegradable composite forming at least a portion of the container. The biodegradable composite may include a biodegradable plastic polymer having a biodegradability of from about 80 percent (%) to about 95 percent (%) when measured according to an ASTM D6400-19 biodegradability standard, wherein a polymeric matrix of the biodegradable plastic polymer has a tensile strength of from about 30 MPa to about 45 MPa and an elastic modulus of from about 2600 MPa to about 3600 MPa. According to an example, the biodegradable composite may include a biodegradable fiber having a tensile strength greater than the tensile strength of the polymeric matrix of the biodegradable plastic polymer and an elastic modulus greater than the elastic modulus of the polymeric matrix.

According to an example, the biodegradable composite may have a tensile strength greater than 45 MPa.

According to an example, the biodegradable composite may have the tensile strength of from about 55 MPa to about 90 MPa.

According to an example, the biodegradable composite may have an elastic modulus greater than about 3600 MPa.

According to an example, the biodegradable plastic polymer may include at least one selected from a group comprising or consisting of poly-3-hydroxybutyrate (“P3HB”), poly-4-hydroxybutyrate (“P4HB”), poly 3-hydroxybutyrate-co-4-hydroxybutyrate (“P3HB-co-4HB”), poly-3-hydroxybutyrate-co-3-hydroxyvalerate (“PHBV”), and pPoly-3-hydroxybutyratehexanoate (“PBHH”), polylactic acid (“PLA”), thermoplastic starch (“TPS”), poly-caprolactone (“PCL”), polybutylene succinate (“PBS”) and polyvinyl alcohol (“PVA”).

According to an example, the biodegradable plastic polymer may include at least one selected from a group comprising or consisting of poly-3-hydroxybutyrate (“P3HB”), poly-4-hydroxybutyrate (“P4HB”), poly 3-hydroxybutyrate-co-4-hydroxybutyrate (“P3HB-co-4HB”), poly-3-hydroxybutyrate-co-3-hydroxyvalerate (“PHBV”), poly-3-hydroxybutyratehexanoate (“PBHH”), polylactic acid (“PLA”), thermoplastic starch (“TPS”), poly-caprolactone (“PCL”), polybutylene succinate (“PBS”), polyglycolic acid (“PGA”), poly(lactic-co-glycolic acid) (“PLGA”), polybutylene adipate terephthalate (“PBAT”) and polyvinyl alcohol (“PVA”).

According to an example, the biodegradable plastic polymer may include poly-3-hydroxybutyrate-co-3-hydroxyvalerate (“PHBV”).

According to an example, the biodegradable fiber includes at least one selected from a group comprising or consisting of flax fiber, hemp fiber, jute fiber, kenaf fiber and bamboo fiber.

According to an example, the bio-derived fiber includes at least one selected from a group comprising or consisting of flax fiber, hemp fiber, ramie fiber, jute fiber, abaca fiber, cantala fiber, henequen fiber, sisal fiber, pineapple fiber, mitsumata fiber, gampi fiber, and kozo fiber.

According to an example, the biodegradable fiber may include hemp fiber.

According to an example, the biodegradable plastic composite may include about 5 weight percent (wt. %) or more of the hemp fiber with respect to a weight of the biodegradable plastic composite and about 30 wt. % or less of the hemp fiber with respect to a weight of the biodegradable plastic composite.

According to an example, the biodegradable plastic composite includes PHBV and about 5 weight percent (wt. %) or more of the hemp fiber with respect to a weight of the biodegradable plastic composite and about 30 wt. % or less of the hemp fiber with respect to a weight of the biodegradable plastic composite.

According to an example, the biodegradable plastic composite may include wax.

According to an example, the wax may be adhered to a surface of the biodegradable fiber.

According to an example, the biodegradable plastic composite may exhibit a water contact angle equal to or greater than about 90°.

According to an example, a biodegradable composite may comprise a biodegradable plastic polymer having a biodegradability of from about 80 to 95 percent (%) within 180 days when measured according to a biodegradability test in accordance with an ASTM D6400 standard, wherein a polymeric matrix of the biodegradable plastic polymer has a tensile strength of about 30 MPa to about 45 MPa and an elastic modulus of from about 2600 MPa to about 3600 MPa. According to an example, the biodegradable polymer may comprise a biodegradable fiber having wax on a surface of the biodegradable fiber. According to an example, the biodegradable fiber may have a density of from about 1.3 g/cm³ to about 1.5 g/cm³, a tensile strength of from about 90 MPa to about 900 MPa; and an elastic modulus of from about 4000 MPa to about 5000 MPa.

According to an example, a biodegradable composite may comprise a biodegradable plastic polymer having a biodegradability of from about 80 to 95 percent (%) within 180 days when measured according to a biodegradability test in accordance with an ASTM D6400-19 standard, wherein a polymeric matrix of the biodegradable plastic polymer has a tensile strength of about 30 MPa to about 45 MPa and an elastic modulus of from about 2600 MPa to about 3600 MPa. According to an example, the biodegradable polymer may comprise a biodegradable fiber having wax on a surface of the biodegradable fiber. According to an example, the biodegradable fiber may have a density of from about 1.3 g/cm³ to about 1.5 g/cm³, a tensile strength of from about 90 MPa to about 900 MPa; and an elastic modulus of from about 4000 MPa to about 5000 MPa.

According to an example, the biodegradable composite may have the tensile strength of from about 55 MPa to about 90 MPa. According to an example, the biodegradable plastic composite may exhibit a water contact angle equal to or greater than about 90°.

According to an example, the biodegradable plastic polymer may include at least one selected from a group comprising or consisting of poly-3-hydroxybutyrate (“P3HB”), poly-4-hydroxybutyrate (“P4HB”), poly 3-hydroxybutyrate-co-4-hydroxybutyrate (“P3HB-co-4HB”), poly-3-hydroxybutyrate-co-3-hydroxyvalerate (“PHBV”), and pPoly-3-hydroxybutyratehexanoate (“PBHH”), polylactic acid (“PLA”), thermoplastic starch (“TPS”), poly-caprolactone (“PCL”), polybutylene succinate (“PBS”) and polyvinyl alcohol (“PVA”), and the biodegradable fiber includes at least one selected from a group comprising or consisting of flax fiber, hemp fiber, jute fiber, kenaf fiber and bamboo fiber.

According to an example, the biodegradable plastic polymer may include at least one selected from a group comprising or consisting of poly-3-hydroxybutyrate (“P3HB”), poly-4-hydroxybutyrate (“P4HB”), poly 3-hydroxybutyrate-co-4-hydroxybutyrate (“P3HB-co-4HB”), poly-3-hydroxybutyrate-co-3-hydroxyvalerate (“PHBV”), poly-3-hydroxybutyratehexanoate (“PBHH”), polylactic acid (“PLA”), thermoplastic starch (“TPS”), poly-caprolactone (“PCL”), polybutylene succinate (“PBS”), polyglycolic acid (“PGA”), poly(lactic-co-glycolic acid) (“PLGA”), polybutylene adipate terephthalate (“PBAT”) and polyvinyl alcohol (“PVA”), and the biodegradable fiber includes at least one selected from a group comprising or consisting of flax fiber, hemp fiber, ramie fiber, jute fiber, abaca fiber, cantala fiber, henequen fiber, sisal fiber, pineapple fiber, mitsumata fiber, gampi fiber, and kozo fiber.

According to an example, a method of producing a biodegradable composite may comprise wetting a biodegradable fiber with wax emulsion and fusing the biodegradable fiber having the wax with a biodegradable plastic polymer having a biodegradability of from about 80 to 95 percent (%) within 180 days, when measured according to a biodegradability test in accordance with an ASTM D6400 biodegradability standard, wherein a polymeric matrix of the biodegradable plastic polymer has a tensile strength of about 30 MPa to about 45 MPa and an elastic modulus of from about 2600 MPa to about 3600 MPa, and wherein the biodegradable fiber has a tensile strength greater than the tensile strength of the polymeric matrix of the biodegradable plastic polymer and an elastic modulus greater than the elastic modulus of the polymeric matrix.

According to an example, a method of producing a biodegradable composite may comprise wetting a biodegradable fiber with wax emulsion and fusing the biodegradable fiber having the wax with a biodegradable plastic polymer having a biodegradability of from about 80 to 95 percent (%) within 180 days, when measured according to a biodegradability test in accordance with an ASTM D6400-19 biodegradability standard, wherein a polymeric matrix of the biodegradable plastic polymer has a tensile strength of about 30 MPa to about 45 MPa and an elastic modulus of from about 2600 MPa to about 3600 MPa, and wherein the biodegradable fiber has a tensile strength greater than the tensile strength of the polymeric matrix of the biodegradable plastic polymer and an elastic modulus greater than the elastic modulus of the polymeric matrix.

According to an example, a container may comprise a biodegradable composite forming at least a portion of the container, where the biodegradable composite may include a biodegradable plastic polymer having a biodegradability of from about 80 percent (%) to about 95% when measured according to a biodegradability test in accordance with an ASTM D6400-19 standard, and a bio-derived fiber infused with a bio-derived wax to have a surface energy of from about 45 milli-Joule per square meter (mJ/m²) to about 50 mJ/m², wherein a polymeric matrix of the biodegradable plastic polymer may have a tensile strength of from about 30 MPa to about 45 MPa and an elastic modulus of from about 2600 MPa to about 3600 MPa, and wherein the bio-derived fiber has an average diameter of from about 20 microns to about 30 microns, an average length of from about 15 mm to about 20 mm, and a tensile strength greater than the tensile strength of the polymeric matrix of the biodegradable plastic polymer and an elastic modulus greater than the elastic modulus of the polymeric matrix.

According to an example, the biodegradable composite may have a tensile strength greater than about 45 MPa.

According to an example, the biodegradable composite may have an elastic modulus greater than about 3600 MPa.

According to an example, the biodegradable plastic polymer may include at least one selected from a group comprising or consisting of poly-3-hydroxybutyrate (“P3HB”), poly-4-hydroxybutyrate (“P4HB”), poly 3-hydroxybutyrate-co-4-hydroxybutyrate (“P3HB-co-4HB”), poly-3-hydroxybutyrate-co-3-hydroxyvalerate (“PHBV”), and pPoly-3-hydroxybutyratehexanoate (“PBHH”), polylactic acid (“PLA”), thermoplastic starch (“TPS”), poly-caprolactone (“PCL”), polybutylene succinate (“PBS”) and polyvinyl alcohol (“PVA”).

According to an example, the biodegradable plastic polymer may include at least one selected from a group comprising or consisting of poly-3-hydroxybutyrate (“P3HB”), poly-4-hydroxybutyrate (“P4HB”), poly 3-hydroxybutyrate-co-4-hydroxybutyrate (“P3HB-co-4HB”), poly-3-hydroxybutyrate-co-3-hydroxyvalerate (“PHBV”), poly-3-hydroxybutyratehexanoate (“PBHH”), polylactic acid (“PLA”), thermoplastic starch (“TPS”), poly-caprolactone (“PCL”), polybutylene succinate (“PBS”), polyglycolic acid (“PGA”), poly(lactic-co-glycolic acid) (“PLGA”), polybutylene adipate terephthalate (“PBAT”) and polyvinyl alcohol (“PVA”).

According to an example, the biodegradable plastic polymer may include poly hydroxybutyrate-co-3-hydroxyvalerate (“PHBV”).

According to an example, the biodegradable fiber includes at least one selected from a group comprising or consisting of flax fiber, hemp fiber, jute fiber, kenaf fiber and bamboo fiber.

According to an example, the bio-derived fiber includes at least one selected from a group comprising or consisting of flax fiber, hemp fiber, ramie fiber, jute fiber, abaca fiber, cantala fiber, henequen fiber, sisal fiber, pineapple fiber, mitsumata fiber, gampi fiber, and kozo fiber.

According to an example, the bio-derived fiber infused with the bio-derived wax may include a hemp fiber.

According to an example, the biodegradable plastic polymer may include poly-3-hydroxybutyrate-co-3-hydroxyvalerate (“PHBV”), and an amount of the hemp fiber in the biodegradable composite may be about 5 weight percent (wt. %) or more of the hemp fiber with respect to a weight of the biodegradable plastic composite and about 30 wt. % or less of the hemp fiber with respect to a weight of the biodegradable plastic composite.

According to an example, the bio-derived wax may include beeswax.

According to an example, the biodegradable composite may exhibit a water contact angle equal to or greater than about 90°.

According to an example, a biodegradable composite may include a biodegradable plastic polymer having a biodegradability of from about 80 to 95 percent (%) within 180 days when measured according to a biodegradability test in accordance with an ASTM D6400-19 standard, and a bio-derived fiber infused with a bio-derived wax to have a surface energy of from about 45 millijoule per meter-square (mJ/m²) to about 50 mJ/m², wherein a polymeric matrix of the biodegradable plastic polymer may have a tensile strength of about 30 MPa to about 45 MPa and an elastic modulus of from about 2600 MPa to about 3600 MPa, and wherein the bio-derived fiber may have an average diameter of from about 20 microns (μm) to about 30 microns, an average length of from about 15 mm to about 20 mm, and a tensile strength greater than the tensile strength of the polymeric matrix of the biodegradable plastic polymer and an elastic modulus greater than the elastic modulus of the polymeric matrix.

According to an example, the biodegradable composite may have a tensile strength greater than about 45 MPa.

According to an example, the biodegradable composite may have an elastic modulus greater than about 3600 MPa.

According to an example, the biodegradable plastic polymer may include at least one selected from a group comprising or consisting of poly-3-hydroxybutyrate (“P3HB”), poly-4-hydroxybutyrate (“P4HB”), poly 3-hydroxybutyrate-co-4-hydroxybutyrate (“P3HB-co-4HB”), poly-3-hydroxybutyrate-co-3-hydroxyvalerate (“PHBV”), and pPoly-3-hydroxybutyratehexanoate (“PBHH”), polylactic acid (“PLA”), thermoplastic starch (“TPS”), poly-caprolactone (“PCL”), polybutylene succinate (“PBS”) and polyvinyl alcohol (“PVA”).

According to an example, the biodegradable plastic polymer may include at least one selected from a group comprising or consisting of poly-3-hydroxybutyrate (“P3HB”), poly-4-hydroxybutyrate (“P4HB”), poly 3-hydroxybutyrate-co-4-hydroxybutyrate (“P3HB-co-4HB”), poly-3-hydroxybutyrate-co-3-hydroxyvalerate (“PHBV”), poly-3-hydroxybutyratehexanoate (“PBHH”), polylactic acid (“PLA”), thermoplastic starch (“TPS”), poly-caprolactone (“PCL”), polybutylene succinate (“PBS”), polyglycolic acid (“PGA”), poly(lactic-co-glycolic acid) (“PLGA”), polybutylene adipate terephthalate (“PBAT”) and polyvinyl alcohol (“PVA”).

According to an example, the biodegradable plastic polymer may include poly-3-hydroxybutyrate-co-3-hydroxyvalerate (“PHBV”).

According to an example, the biodegradable fiber includes at least one selected from a group comprising or consisting of flax fiber, hemp fiber, jute fiber, kenaf fiber and bamboo fiber.

According to an example, the bio-derived fiber includes at least one selected from a group comprising or consisting of flax fiber, hemp fiber, ramie fiber, jute fiber, abaca fiber, cantala fiber, henequen fiber, sisal fiber, pineapple fiber, mitsumata fiber, gampi fiber, and kozo fiber.

According to an example, the bio-derived fiber infused with the bio-derived wax may include a hemp fiber.

According to an example, the biodegradable plastic polymer may include poly-3-hydroxybutyrate-co-3-hydroxyvalerate (“PHBV”), and an amount of the hemp fiber in the biodegradable composite may be about 5 weight percent (wt. %) or more of the hemp fiber with respect to a weight of the biodegradable plastic composite and about 30 wt. % or less of the hemp fiber with respect to a weight of the biodegradable plastic composite.

According to an example, the bio-derived wax may include beeswax.

According to an example, the biodegradable composite may exhibit a water contact angle equal to or greater than about 90°.

For example, the biodegradable composite may have a tensile strength greater than about 45 MPa, and the biodegradable plastic composite may exhibit a water contact angle equal to or greater than about 90°.

According to an example, the biodegradable plastic polymer may include at least one selected from a group comprising or consisting of poly-3-hydroxybutyrate (“P3HB”), poly-4-hydroxybutyrate (“P4HB”), poly 3-hydroxybutyrate-co-4-hydroxybutyrate (“P3HB-co-4HB”), poly-3-hydroxybutyrate-co-3-hydroxyvalerate (“PHBV”), and pPoly-3-hydroxybutyratehexanoate (“PBHH”), polylactic acid (“PLA”), thermoplastic starch (“TPS”), poly-caprolactone (“PCL”), polybutylene succinate (“PBS”) and polyvinyl alcohol (“PVA”), and the biodegradable fiber includes at least one selected from a group comprising or consisting of flax fiber, hemp fiber, jute fiber, kenaf fiber and bamboo fiber.

According to an example, the biodegradable plastic polymer may include at least one selected from a group comprising or consisting of poly-3-hydroxybutyrate (“P3HB”), poly-4-hydroxybutyrate (“P4HB”), poly 3-hydroxybutyrate-co-4-hydroxybutyrate (“P3HB-co-4H B”), poly-3-hydroxybutyrate-co-3-hydroxyvalerate (“P H By”), poly hydroxybutyratehexanoate (“PBHH”), polylactic acid (“PLA”), thermoplastic starch (“TPS”), poly-caprolactone (“PCL”), polybutylene succinate (“PBS”), polyglycolic acid (“PGA”), poly(lactic-co-glycolic acid) (“PLGA”), polybutylene adipate terephthalate (“PBAT”) and polyvinyl alcohol (“PVA”), and the biodegradable fiber includes at least one selected from a group comprising or consisting of flax fiber, hemp fiber, ramie fiber, jute fiber, abaca fiber, cantala fiber, henequen fiber, sisal fiber, pineapple fiber, mitsumata fiber, gampi fiber, and kozo fiber.

According to an example, the biodegradable plastic polymer may include poly-3-hydroxybutyrate-co-3-hydroxyvalerate (“PHBV”), and an amount of the hemp fiber in the biodegradable composite is about 5 weight percent (wt. %) or more of the hemp fiber with respect to a weight of the biodegradable plastic composite and about 30 wt. % or less of the hemp fiber with respect to a weight of the biodegradable plastic composite.

According to an example, a method of producing a biodegradable composite may include wetting a bio-derived fiber with an wax emulsion including a bio-derived wax, to infuse the bio-derived fiber with the bio-derived wax to have a surface energy of about 45 mJ/m²-about 50 mJ/m², and fusing the bio-derived fiber infused with the bio-derived wax with a biodegradable plastic polymer having a biodegradability of from about 80 to 95 percent (%) within 180 days, when measured according to a biodegradability test in accordance with an ASTM D6400-19 standard, wherein a polymeric matrix of the biodegradable plastic polymer may have a tensile strength of about 30 MPa to about 45 MPa and an elastic modulus of from about 2600 MPa to about 3600 MPa, and wherein the bio-derived fiber may have an average diameter of from about 20 microns to about 30 microns, an average length of from about 15 mm to about 20 mm, and a tensile strength greater than the tensile strength of the polymeric matrix of the biodegradable plastic polymer and an elastic modulus greater than the elastic modulus of the polymeric matrix.

According to an example, the biodegradable composite may have a tensile strength greater than about 45 MPa.

According to an example, the biodegradable composite may have an elastic modulus greater than about 3600 MPa.

According to an example, the biodegradable plastic polymer may include at least one selected from a group comprising or consisting of poly-3-hydroxybutyrate (“P3HB”), poly-4-hydroxybutyrate (“P4HB”), poly 3-hydroxybutyrate-co-4-hydroxybutyrate (“P3HB-co-4HB”), poly-3-hydroxybutyrate-co-3-hydroxyvalerate (“PHBV”), and pPoly-3-hydroxybutyratehexanoate (“PBHH”), polylactic acid (“PLA”), thermoplastic starch (“TPS”), poly-caprolactone (“PCL”), polybutylene succinate (“PBS”) and polyvinyl alcohol (“PVA”).

According to an example, the biodegradable plastic polymer may include at least one selected from a group comprising or consisting of poly-3-hydroxybutyrate (“P3HB”), poly-4-hydroxybutyrate (“P4HB”), poly 3-hydroxybutyrate-co-4-hydroxybutyrate (“P3HB-co-4H B”), poly-3-hydroxybutyrate-co-3-hydroxyvalerate (“PHBV”), poly-3-hydroxybutyratehexanoate (“PBHH”), polylactic acid (“PLA”), thermoplastic starch (“TPS”), poly-caprolactone (“PCL”), polybutylene succinate (“PBS”), polyglycolic acid (“PGA”), poly(lactic-co-glycolic acid) (“PLGA”), polybutylene adipate terephthalate (“PBAT”) and polyvinyl alcohol (“PVA”).

According to an example, the biodegradable plastic polymer may include poly-3-hydroxybutyrate-co-3-hydroxyvalerate (“PHBV”).

According to an example, the biodegradable fiber includes at least one selected from a group comprising or consisting of flax fiber, hemp fiber, jute fiber, kenaf fiber and bamboo fiber.

According to an example, the bio-derived fiber includes at least one selected from a group comprising or consisting of flax fiber, hemp fiber, ramie fiber, jute fiber, abaca fiber, cantala fiber, henequen fiber, sisal fiber, pineapple fiber, mitsumata fiber, gampi fiber, and kozo fiber.

According to an example, the bio-derived fiber infused with the bio-derived wax may include a hemp fiber.

According to an example, the biodegradable plastic polymer may include poly hydroxybutyrate-co-3-hydroxyvalerate (“PHBV”), and an amount of the hemp fiber in the biodegradable composite may be about 5 weight percent (wt. %) or more of the hemp fiber with respect to a weight of the biodegradable plastic composite and about 30 wt. % or less of the hemp fiber with respect to a weight of the biodegradable plastic composite.

According to an example, the bio-derived wax may include beeswax.

According to an example, the biodegradable composite may exhibit a water contact angle equal to or greater than about 90°.

According to an example, the term biodegradable plastic polymer, biodegradable plastic, and biodegradable plastic polymer means a polymer that can be degraded relatively more rapidly than a polymer produced from petroleum and not considered degradable or biodegradable in a given bioenvironmental condition. In the meantime, ordinary meaning(s) of the term biodegradable plastic polymer that would be as understood by those skilled in the art is implemented in this disclosure.

For example, the term biodegradable plastic polymer means a degradable plastic polymer in which the degradation results from the action of microorganisms such as bacteria, fungi, and algae. In the meantime, ordinary meaning(s) of the term biodegradable plastic polymer that would be as understood by those skilled in the art is implemented in this disclosure.

For example, compostable plastic means a plastic that undergoes degradation by a biological process during composting to yield CO₂, water, an inorganic compound, and biomass at a rate consistent with other known compostable materials and leave no visible, distinguishable or toxic residue. In the meantime, ordinary meaning(s) of the term compostable plastic that would be as understood by those skilled in the art is implemented in this disclosure.

For example, composting means a process that can be managed and controls the biological decomposition and transformation of biodegradable materials into a humus-like substance called compost: the aerobic mesophilic and thermophilic degradation of organic matter to make compost; the transformation of biologically decomposable material through a controlled process of biooxidation that proceed through mesophilic and thermophilic phases and results in the production of carbon dioxide, water, a mineral, and stabilized organic matter (compost or humus). In the meantime, ordinary meaning(s) of the term composting that would be as understood by those skilled in the art is implemented in this disclosure.

For example, degradable plastic means a plastic designed to undergo a significant change in its chemical structure under a specific environmental condition, resulting in a loss of a property as measured by a standard test method appropriate to the plastic and the application in a period of time that determines its classification. In the meantime, ordinary meaning(s) of the term degradable plastic that would be as understood by those skilled in the art is implemented in this disclosure.

For example, Biodegradation and biodegradability are terms that would be as understood by a person with ordinary skill in the field of the art. Therefore, for example, the term biodegradability can be defined based on conditions surrounding the materials, which may be specified by test standards recognized in the relevant field of the art.

For example, a biodegradability may be a degradability based on a process by which organic substances are decomposed by microorganisms (mainly aerobic bacteria) into simpler substances such as carbon dioxide.

For example, biodegradation may be defined by the biodegradation test of or in accordance with the ASTM D6400 standard, such as ASTM D6400-19, which states that biodegradation is the proportion (e.g., %) of carbon in the material that gets converted into carbon dioxide within 180 days, compared to the positive control (cellulose). For example, the disclosure of the ASTM D6400-19, published in May 2019, is incorporated by reference in its entirety herein. According to an example, biodegradability of a plastic composite may be measured based on the biodegradation test, which is a part of the ASTM D6400-19 standard. There are several types of biodegradation as defined by ASTM (United States), EN (European), ISO (International), NFT (France) and AS 5810 (Australia) standards. ASTM D6400 and EN13432 certify materials to be industrial compostable. NFT 51800, AS 5810 and EN 17427 certify materials to be home compostable. ASTM D6691 and ISO 16221 certify materials to be fresh water biodegradable. In this disclosure, an aspect of biotic phenomena is considered, which will result in the biodegradation of bioplastic. There is also an abiotic process (which includes UV degradation and oxidation) which causes degradation.

According to an example, three procedures from the ASTM D6400-19 standardization may be used to test, respectively, disintegration, biodegradation and quality of compost produced, also known as the industrial compostability test.

For example, in a case where the bioplastics or biodegradable plastics as a biodegradable plastic polymer are composted in a compost facility, the given surrounding conditions may contain foodwaste feed stock, in combination with a controlled rising temperature (from 20° C.-75° C.). The compost conditions may have a moisture content of 40-60%; at lower levels than 40%, the microbial activity can be limited and at higher levels than 60% the process can become foul smelling due to anaerobic activity. The initial compost conditions may have an initial pH of 4.5-5 and then may rise to a final pH of 8. At lower pH levels then 4.5 and higher pH levels than 8; the compost may produce foul smells. The composting process generally has the following three phases: a mesophilic phase, a thermophilic phase and a curing phase. The thermophilic phase facilitates the break down or biodegradation, such as a biodegradation of the PHBV and the hemp fiber in the proposed polymer. For example, enzymatic hydrolysis of PHBV which, occurs in the thermophilic phase, is what breaks down PHBV and/or the cellulose derived hemp into CO₂.

For example, microbes may be found in the thermophilic phase during compost, which can colonize at the surface of the PHBV and/or hemp fiber material. Afterwards, plastics may be enzymatically degraded in the following two-step process: first the enzyme binds to the surface of the plastic and/or fiber substrate, and, secondly, the enzymatic catalysis of the hydrolytic cleavage resulting in the reduction of the carbon polymer chain length into low molecular weight oligomers, dimers and monomers. When carbon polymer chains are short enough, they can be assimilated by microorganisms and ultimately converted aerobically into biomass, water and/or CO₂.

The mesophilic phase may last 72 hours and start at 20° C. and end at 40° C. This mesophilic phase may involve a type of bacteria such as Psuedomonas, Bacillus and Flavobacterium, a type of actinomycetes such as streptomyces and/or may involve a type of fungi such as penicillium, humicola and mucor. The thermophilic phase may last 10-60 days and start at 40° C. and end at 75° C. This thermophilic phase may contain a type of bacteria such as bacillus and thermus, may contain a type of actinomycetes such as streptomyces and thermomonospora, and/or may contain fungi such as aspergillus, torula and absidia. The curing phase may last 3-5 months and may contain similar species with respect to the mesophilic and thermophilic phases, as the compost pile cools from 75° C., back to 20° C.

There is an industrial composting standard certification for United States and an industrial composting standard certification for Europe. Both standards are standard compostability tests that include biodegradation tests. The biodegradation tests measure aerobic biodegradation of plastic materials under controlled composting conditions. The ASTM 6400 standard is the regulatory framework for the United States and sets a threshold of 90% biodegradation within 180 days ASTM. This standard allows the use of the “BPI OK Compost” logo on materials approved under the ASTM 6400 standard. The EN 13432 (European) industrial standard may be considered as the internationally accepted standard in scope, and compliance with this standard is required to claim that a product is bio-compostable in the European marketplace. The EN 13432 standard requires biodegradation of 90% of the materials in a commercial composting unit within 180 days. This standard enables the applicant to use the “TUV Austria OK Compost” logo on materials approved under the EN 13432 standard.

According to an example, a procedure of the ASTM 6400 standard can test in a lab setting.

According to an example, in order to be identified as compostable in municipal or industrial aerobic facilities via ASTM D6400-19, a product is to pass the three different requirements or tests of ASTM D6400-19—disintegration during composting, biodegradation and a quality of compost test—using the appropriate laboratory tests which represent conditions found in an aerobic composting facility.

For example, for the first requirement of the ASTM D6400-19, in summary, as a disintegration test, starting with the different varieties of a biodegradable plastic product such as the 8 oz cup, its product pieces cut to 2 cm in length, in 180 days of composting under laboratory controlled composting conditions, 90% of the product is expected to pass a 2 mm sieve, in accordance with ASTM D6400-19, to be considered 60% biodegradable (or 90% biodegradable).

For example, for the second requirement, as a biodegradation test, 60% 90% of the organic carbon is expected to be converted to carbon dioxide by the end of the test period, when compared to the positive control (cellulose).

For example, for the third requirement, as a compost quality test, with respect to plant growth, the germination rate and the plant biomass of the sample composts is expected to be no less than 90% that of the corresponding blank composts for two different plant species. Moreover, the section two of ASTM D6400-19 states that heavy metal concentrations are to be below a certain threshold to meet the standard.

According to an example, a test among disintegration test, biodegradability test and compost quality test based on the ASTM D6400-19 standard may be conducted. For example, a temperature controlled incubator capable of holding a certain temperature level, such as at 60° C., over the length of the test procedure may be used. Composting vessels, such as a cylindrical composting vessels may be used. The containers may have two sections separated by a porous pad so the top section has free volume, water can be placed in the bottom section and the test material (inoculum plus testing material) can be placed on top.

According to an example, a composite, such as a 3 month old stable compost, may be used for the inoculum. The compost can be sieved through a 9.5 sieve and then mixed. Ammonium chloride may be added so that the C/N (carbon/nitrogen) ratio is, for example, less than 15, and the appropriate amount of water to bring the moisture content to 50%.

According to an example, the disintegration and biodegradation tests may be tested separately, while it can be performed in the same incubator or different incubator. For example, 2 cm×2 cm squares of biodegradable composite may be tested and added to 1200 g of compost and put the mixture in the composting vessels (top section). For example, the mixture may be composted for 180 days at 58° C. The composting vessel may be shaken weekly to mix the sample & compost and to suppress extensive channeling, to provide uniform attack on the test specimen, and/or to provide an even distribution of moisture. At the end of 12 weeks material may be emptied from the composting vessels and screened through a 2 mm sieve. A plastic product is considered to have demonstrated satisfactory disintegration if after twelve weeks (84 days) in a controlled composting test, no more than 10% of its original dry weight remains after sieving on a 2.0-mm sieve.

For example, the biodegradation testing may be conducted in triplicate on each of the following:

1.) the sample (100 g of sample+600 g dry weight of compost),

2.) positive control (100 g of cellulose+600 g dry weight of compost),

3.) negative control (100 g of polyethylene+600 g dry weight of compost), and

4.) blank (600 g dry weight of compost).

The moisture content of the mixtures may be adjusted or controlled to 50%, then the mixture may be put into the composting vessels. The composting vessels may be placed in the incubator at 58° C. The CO₂ free air may be then connected and adjusted around or at a flow rate that is, for example, between 150 and 200 ml per minute. The gases exiting the test chambers may be plumbed to a solenoid valve which is controlled to divert air for 2 minutes out of every 2 hours. These diverted gases can flow into an adsorption unit containing a known volume of, for example, 1N sodium hydroxide to adsorb the carbon dioxide being produced in the vessels (for the remainder to the 2 hours the exhaust is simply vented to the room). The sodium hydroxide may be periodically titrated to measure the CO₂ production. Days for the titration may be, for example, 3, 7, 14, and every 7 days after that. The solution may be titrated, for example, to pH 8.5 with 0.5N HCl after adding BaCl₂ to precipitate the carbonates formed by the CO₂. For example, fresh 1N sodium hydroxide may be placed in the absorption units and the whole process is repeated. The testing is carried out until the CO₂ production from both the sample and the positive control have plateaued up to a maximum of 180 days.

According to an example, for the plant growth study (compost quality), pots used may be used that can hold in moisture, for example, to reduce the need to water which could lead to leaching of phytotoxins out of the material being tested. For example, several dilutions may be made by diluting the sample with vermiculite. The same dilutions may be also conducted on the positive control (cellulose). For example, an amount of seeds such as 500 mg (e.g., corn, cucumber, etc.) may be planted into each cup. A plant density scale may be developed using different densities of seeds in determining percent germination. For example, the index value of the control may be considered as 100 percent germination when determining the index of the sample. For example, biomass may be based on average height of healthy plants.

An example according to the disclosure may relate to a method of raw material treatment, resin production via extrusion using treated raw material and/or finished product development via injection molding. An example according to the disclosure may relate to a method for surface treatment of a fibrous material or fibers to increase adhesion to the main biodegradable polymeric matrix. An example according to the disclosure may relate to production of a composite containing a biodegradable polymer and a fibrous material using a process such as a screw extrusion.

According to an example, a biodegradable polymer can be selected from a variety of materials that can be biodegradable and may include one or more biodegradable polymer types. According to an example, a fibrous material or fiber can be selected from a variety of materials that are fibrous and may include one or more fibrous material/fiber types. An example according to the disclosure relates to producing a variety of products, components, parts or objects using a composite including a biodegradable polymer and a fibrous material such as fiber. An example may include a production of a container, for example, a container to contain an edible substance, such as a food container and a beverage container. For example, a container may include 8 oz. cup. According to an example, such a production may be performed based on a variety of production methods such as a deductive production method and an additive production method, an example of which may include injection molding, 3D printing and extrusion.

An example according to the disclosure relates to methods for producing a composite containing a surface-treated fibrous material such as a surface-treated fiber or a fiber infused with another material or a fiber permeated with another material. According to an example, a fibrous material such as a fiber may be surface treated with a treating agent or a fiber infused with a treating agent or a fiber permeated with a treating agent. According to an example, a treating agent means one or more types of treating agent. According to an example, a surface treatment, infusion, and/or permeation of a fiber with another material or agent may be performed to alter the surface characteristics or a property of the fiber. For example, a fiber can be surface treated, be infused with another material or agent, or be permeated with another material or agent, to change the hydrophobicity or hydrophilicity of the fiber or to change the compatibility between a fiber and a biodegradable polymer.

According to an example, biodegradable plastics or biodegradable polymer may have compostability and biodegradability.

According to an example, biodegradable plastics or a biodegradable polymer to be used as a base polymer matrix of a biodegradable composite may include a variety of polymers that are relatively biodegradable relative to commonly used plastics and polymers are not considered biodegradable. According to an example, biodegradable plastics or a biodegradable polymer to be used as a base polymer matrix of a biodegradable composite may include plastics or polymer exhibiting about 80 to 95 percent (%) biodegradability within 180 days when exposed to a biodegradable condition in accordance with ASTM D6400-19.

According to an example, biodegradable plastics or a biodegradable polymer may exhibit properties that are sufficient, for example, to function as a product or to be adequate to be used for a manufacturing process. Such properties may include, but not limited, a mechanical property, a thermal property and/or surface property.

According to an example, a material or a product formed from a biodegradable polymer may have a tensile strength in the range of from about 30 MPa to about 45 MPa. For example, the higher the tensile strength, the more force the material can withstand without breaking or tearing. For example, when the tensile strength of the material or the product formed from the biodegradable polymer is less than about 30 MPa, a composite or a product produced from the biodegradable polymer may not have sufficient tensile strength to withstand breaking or tearing. For example, when the tensile strength of the material or the product formed from the biodegradable polymer is more than about 80 MPa, the material may become too rigid for a function of the material or the product. For example, if the material is too rigid, it is less versatile and can be specifically used for rigid materials and not elastic materials.

According to an example, a material or a product formed from a biodegradable polymer may have an elastic modulus in the range of from about 2600 MPa to about 3600 MPa. For example, the higher the elastic modulus, the more resistant the material is to deformation. For example, when the elastic modulus of the material or the product formed from the biodegradable polymer is less than about 2600 MPa, the material or the product may break easily when deformation occurs. When the elastic modulus of the material or the product formed from the biodegradable polymer is more than about 5500 MPa, the material may be too elastic to, for example, to maintain a structural integrity to function. For example, if the material is too elastic, the material may be too elastic for certain packaging material, thus affecting its versatility.

According to an example, a material or a product formed from a biodegradable polymer may have a degree of crystallinity of from about 35% to about 50%. The higher the crystallinity, the more aligned regularly aligned its chains are. A higher degree of crystallinity also correlates to higher tensile strength. For example, when the degree of crystallinity of the material or the product formed from the biodegradable polymer is less than about 35%, the material may be weak and brittle. For example, when the degree of crystallinity of the material or the product formed from the biodegradable polymer is more than about 90%, the material may be too rigid. For example, if a material is too rigid, the material may be less versatile and can be specifically used for rigid materials and not for elastic materials.

According to an example, the polymeric matrix formed from biodegradable plastics or a biodegradable polymer may have a density of about from 1.1 g/cm³ to about 1.3 g/cm³. For example, the polymeric matrix formed from biodegradable plastics may have a density equivalent of current petroleum based plastics such as polypropylene & polyethylene; which have densities between 1.1 g/cm³-1.3 g/cm³.

According to an example, the polymeric matrix formed from biodegradable plastics or a biodegradable polymer may have a tensile strength of about 30 MPa to about 45 MPa. To develop a biodegradable plastic that is similar in tensile strength to petroleum based plastics such as polypropylene & polyethylene; the neat polymeric matrix may have a tensile strength in the range of 30 MPa to 45 MPa to meet the range of mechanical properties.

According to an example, the polymeric matrix formed from biodegradable plastics or a biodegradable polymer may have from about 1% to about 5% elongation at break. Elongation at break is the ratio between increased length and initial length after breakage of the tested material, making it a dimensionless unit. In other words, elongation at break is the percentage increase in length that a material will achieve before breaking. To develop a biodegradable plastic that has similar elongation at break % compared to petroleum based plastics such as polypropylene & polyethylene; the neat polymeric matrix may have the range of 1% to 5% elongation at break.

According to an example, the polymeric matrix formed from biodegradable plastics or a biodegradable polymer may have an elastic modulus of from about 2600 MPa to about 3600 MPa. To develop a biodegradable plastic that has a similar elastic modulus compared to petroleum based plastics such as polypropylene & polyethylene; the neat polymeric matrix may have an elastic modulus in the range of 2600 MPa to 3600 MPa to meet the range of mechanical properties. If the elastic modulus is below 2600 MPa, the material will be relatively too elastic for the development of the 8 oz. cup, which will lead to insufficient characteristics compared to cups on the market. If the elastic modulus is above 3600 MPa, the material will be relatively too rigid for the development of the 8 oz. cup, which will lead to unfavorable characteristics compared to cups on the market

According to an example, the polymeric matrix formed from biodegradable plastics or a biodegradable polymer may have a degree of crystallinity in the range of from about 35% to about 50%. This range of crystallinity is based on the relation between tensile strength and the degree of crystallinity, meaning this specific range of crystallinity will in turn provide adequate tensile strength. The spec degree of crystallinity represents the signal ratio via X-ray analysis between the crystalline structures and the sum of crystalline structures in addition to non-crystalline structures in the material, making it a dimensionless unit.

According to an example, the polymeric matrix formed from biodegradable plastics or a biodegradable polymer may have a heat of crystallization of from about 3 kilojoule (KJ)/mol to about 5 KJ/mol. To develop a biodegradable plastic that has a similar heat of crystallization compared to petroleum based plastics such as polypropylene & polyethylene; the neat polymeric matrix may have a heat of crystallization in the range of 3 KJ/mol to 5 KJ/mol to meet the range of mechanical properties

According to an example, the polymeric matrix formed from biodegradable plastics or a biodegradable polymer may have a surface energy of from about 40 mJ/m² to about 50 mJ/m². Since it is to develop a biodegradable plastic that has a similar surface energy compared to petroleum based plastics such as polypropylene & polyethylene, the neat polymeric matrix may have a surface energy in the range of 40 mJ/m² to 50 mJ/m² to meet the range of mechanical properties

According to an example, the polymeric matrix formed from biodegradable plastics or a biodegradable polymer may exhibit a water contact angle from about 60° to about 80°. To develop a biodegradable plastic that has a similar water contact angle compared to petroleum based plastics such as polypropylene & polyethylene; the neat polymeric matrix may have a water contact angle as close to 70° or higher; since the material is categorized as hydrophobic if the water contact angle exceeds 70°.

According to an example, biodegradable plastics or a biodegradable plastic polymer may be a polymer selected from poly-3-hydroxybutyrate (“P3HB”), poly-4-hydroxybutyrate (“P4HB”), poly 3-hydroxybutyrate-co-4-hydroxybutyrate (“P3HB-co-4HB”), poly-3-hydroxybutyrate-co-3-hydroxyvalerate (“PHBV”), poly-3-hydroxybutyratehexanoate (“PBHH”), polylactic acid (“PLA”), thermoplastic starch (“TPS”), poly-caprolactone (“PCL”), polybutylene succinate (“PBS”), polyglycolic acid (“PGA”), poly(lactic-co-glycolic acid) (“PLGA”), polybutylene adipate terephthalate (“PBAT”) and polyvinyl alcohol (“PVA”).

According to an example, the base polymer may be PHBV. PHBV has about 90% to about 95% biodegradability within 180 days when exposed to a biodegradable condition in accordance with ASTM D6400-19. PHBV exhibits tensile strength of from about 40 to about 45 MPa and elastic modulus of from about 2800 to about 3000 MPa. PHBV exhibits the degree of crystallinity of from about 40% to about 45% and the heat of crystallization of from about 4 KJ/mol to about 4.5 KJ/mol. PHBV has a surface energy of about 40 mJ/m² to about 45 mJ/m² and the contact angle of from about 75° to about 80°.

According to an example, the biodegradable composite may include a biofiber or a bio-derived fiber or a biodegradable fiber.

According to an example, a fiber as a biofiber or a bio-derived fiber or a biodegradable fiber may be selected based on biodegradability and/or tensile strength. For example, since one of the purposes of a reinforcement fiber is to increase tensile strength, a fiber that has a higher tensile strength possible may be chosen. For example, a plant-derived fiber having sufficient biodegradability and/or sufficient tensile strength may be selected. For example, in terms of the biodegradable plant fiber reinforcement material, a fiber with an elastic modulus that is, for example, greater than the polymeric matrix (for example, from about 4000 MPa to about 5000 MPa) may be selected. According to an example, the fiber may be selected or controlled to have an elastic modulus less than about 5000 MPa. For example, when the elastic modulus of the fiber has the elastic modulus higher than 5000 MPa, the material may be too rigid to, for example, maintain too much structural flexibility to perform a function of the product or the material. For example, if the material is too elastic, the material may be too elastic for a certain material application, thus affecting its versatility.

According to an example, the fiber may have a density of from about 1.0 g/cm³ to about 3.0 g/cm³. If the density is below 1.0 g/cm³, then the fiber may be relatively light and mechanical properties such as tensile strength and elastic modulus may weaken. If the density is above 3.0 g/cm³ then the fiber can be too heavy and increase energy output for processing equipment such as the screw extruder.

According to an example, the fiber may have a tensile strength of from about 100 MPa to about 2000 MPa. If the tensile strength is below 100 MPa, then the fiber would be too weak to be used as a reinforcement agent. If the tensile strength is above 2000 MPa, then the material would be too strong for the screw extruder and may damage the machine.

According to an example, the fiber may have an elastic modulus of from about 2000 MPa to about 7000 MPa. If the elastic modulus is below 2000 MPa, then the fiber would break relatively easily under stress. If the elastic modulus is above 7000 MPa, then the material would be relatively too strong for the screw extruder and may damage the machine. The fiber may have an elongation at break of from about 1% to about 10%. These percentages are with respect to the change of length of a material after breakage occurs. If the elongation at break is below 1% (with respect to the change of length under stress), then the material would be relatively too stiff and may affect extrusion processing. If the elongation at break is above 10% (with respect to the change of length under stress), the tensile strength can decrease and thus reduce reinforcement efficiency.

According to an example, the fiber may have a surface energy of about 10-50 mJ/m². If the surface energy is below 10 mJ/m², adhesion between the fiber and the polymeric matrix may not be sufficient. A fiber that is bio-derived fiber and/or biodegradable fiber may tend to not go above a surface energy of 50 mJ/m². Neat fibers that exceed this surface energy are likely synthetic fibers and thus relatively may not be biodegradable. The fiber may have a water contact angle of from about 10° to about 50°. If the water contact angle is below 10°, then the fiber would be relatively too sensitive to moisture absorption and would not be able to be used in fiber reinforced packaging materials. The fiber may tend to not have a water contact angle of 50°; most neat fibers that exceed this water contact angle are synthetic fibers and thus are not biodegradable.

According to an example, a fiber that is considered biodegradable or bio-derived and satisfying these properties may include flax fiber, hemp fiber, ramie fiber, jute fiber, abaca fiber, cantala fiber, henequen fiber, sisal fiber, pineapple fiber, mitsumata fiber, gampi fiber, and kozo fiber.

For example, a hemp fiber has relatively higher tensile strength, which can be from about 800 MPA to about 900 MPa. A hemp fiber has relatively higher elastic modulus value, which can be from about 4500 MPa to about 4800 MPa. A hemp fiber has relatively higher contact angle, which can be from about 35° to about 40°. A hemp fiber has relatively higher surface energy, which can be from about 30 mJ/m² to about 35 mJ/m².

For example, among flax, hemp, jute, kenaf and bamboo fibers, a type of hemp fiber has a relatively higher tensile strength from about 800 MPA to about 900 MPa. For example, in terms of the fiber as a bio-derived fiber and/or biodegradable plant fiber reinforcement material, a fiber with an elastic modulus that is, for example, great than the polymeric matrix may be selected. For example, when the polymeric matrix is based on PHBV, Neat PHBV resin has an elastic modulus range of from about 2800 to about 3000. In this case, a type of hemp fiber having an elastic modulus range of from about 4500 to about 4800 MPa may be selected.

According to an example, a variety of hemp fiber types can be used. For example, a type of a hemp fiber can be derived from a hemp strain called X-59. This strain has relatively higher fiber yield, which can be about 25 to 28% more by weight.

For example, a fiber derived from hemp may be used to improve thermal and/or mechanical properties. For example, the hemp used may be derived from a hemp strain called X-59.

According to an example, the hemp fiber to be used may have an average diameter of from about 20 microns to about 30 microns. The hemp fiber to be used may have an average length of from about 15 mm to about 20 mm. Percent by weight or weight percent (wt. %) in the following description in this paragraph is with respect to the total weight of the hemp fiber. The hemp fiber to be used may contain from about 75 wt. % to about 80 wt. % cellulose. The hemp fiber to be used may contain from about 17.5 wt. % to about 20 wt. % hemicellulose. The hemp fiber to be used may contain from about 2.5 wt. % to about 5 wt. % lignin.

According to an example, reinforcing a biodegradable polymer with a fiber as a biodegradable fiber or a bio-derived fiber with a sufficient mechanical property may increase or synergistically increase a mechanical property of the biodegradable polymer-biodegradable fiber composite (as a biodegradable composite) that can be comparable or equivalent of a material application that is not considered biodegradable or less biodegradable. Moreover, the biodegradability of the biodegradable composite is obtained compared to the material application that is not considered biodegradable or less biodegradable.

According to an example, a surface treated fiber derived from hemp can be used as a filler to reduce production costs.

According to an example, the biodegradable fiber may be surface treated. For example, the biodegradable fiber may be surface treated to improve adhesion with the corresponding polymeric matrix of the biodegradable fiber. For example, to facilitate or increase adhesion between the polymer matrix of the biodegradable polymer and the biodegradable fiber, the surface energy of the biodegradable fiber can be increased by treating the surface of the biodegradable fiber.

For example, hemp fiber not surface treated can have surface energy values of from about 30 mJ/m² to about 35 mJ/m². To facilitate or increase adhesion between the polymer matrix of the biodegradable polymer, such as PHBV, and the biodegradable fiber, such as a hemp fiber, the surface of the biodegradable fiber can be surface treated to match the surface energy of the biodegradable fiber with the surface energy of the biodegradable polymer. For example, when the surface energy of hemp fiber is from about 30 mJ/m² to about 35 mJ/m², the surface of the hemp fiber can be treated to match the surface energy of the PHBV polymer matrix that can have the surface energy level of from about 40 mJ/m² to about 45 mJ/m². According to an example experiment, the surface energy of the treated hemp fiber increased to about 45 mJ/m²-about 50 mJ/m² (From about 45 mJ/m² to about 50 mJ/m². The surface energy was measured with a BIOLIN SCIENTIFIC OPTICAL TENSIOMETER.

According to an example, wax, which may be a biodegradable wax or a bio-derived wax such as beeswax, may be used to surface-treat the fiber. For example, the fiber or the surface of the fiber may be infused with the wax. For example, the fiber or the surface of the fiber may be permeated with the wax. According to an example, surface treatment of the fiber with the wax may reduce the hydrophilic nature of the polymeric matrix of the biodegradable composite.

For example, the wax, which may be a biodegradable wax or a bio-derived wax such as beeswax, may be used to surface-treat the hemp fiber. For example, the hemp fiber or the surface of the hemp fiber may be infused with the wax. For example, the hemp fiber or the surface of the hemp fiber may be permeated with the wax. According to an example, surface treatment of the hemp fiber with the wax may reduce the hydrophilic nature of the polymeric matrix of the biodegradable composite.

According to an example, the wax may exhibit a contact angle of from about 95° to about 110°. The wax may exhibit a melting point of from about 60° C. to about 70° C. The wax may exhibit a total melting enthalpy of from about 150 Joule (J)/gram (g) to about 160 joule per gram (J/g). The wax may have a fatty acid ester content of from about 65% to about 75% by weight of the wax.

According to an example, a variety of different wax types satisfying at least some of the above-disclosed wax properties can be used to surface treat the fiber. An Example satisfying the above-disclosed wax properties include candelilla wax, carnauba wax, beeswax, berry wax and sunflower wax. For example, beeswax may be used. For example, natural wax or biodegradable wax or bio-derived wax such as beeswax may be used to surface treat, infuse, permeate and/or coat the hemp fiber or the surface of the hemp fiber. According to example, surface treatment, infusion, permeation, and/or coating of the hemp fiber with the beeswax may reduce the hydrophilic nature of the polymeric matrix. The beeswax can exhibit a contact angle of from about 105° to about 110°. The beeswax can exhibit a melting point of from about 65° C. to about 70° C. The beeswax can exhibit a total melting enthalpy of from about 155 J/g to about 160 J/g. The beeswax can have a fatty acid ester content of from about 70% to about 75% by weight of the beeswax.

According to an example, beeswax may be used to surface-treat, infuse, permeate, and/or coat the hemp fiber and/or the hemp fiber may be surface-treated in order to increase fiber to matrix adhesion with respect to the polymeric matrix, in the form of increasing the surface roughness of the fiber.

For example, an example relates generally to bio-composite materials and methods for making the material. For example, an example relates to methods for producing composites of natural hemp fibers and poly(3-hydroxybutyrate-co-3-hydroxyvalerate) (PHBV) polymers. For example, an example relates to methods for producing a composite of surface treated hemp finer infused or coated with beeswax and poly(3-hydroxybutyrate-co-3-hydroxyvalerate) (PHBV).

According to an example, a composite material may include a matrix composed of a polyhydroxyalkanoate (PHA) polymer, such as poly(3-hydroxybutyrate-co-3-hydroxyvalerate) (PHBV), and a fibrous filler with particle dimensions.

According to an example, the fibrous filler may be derived from hemp. For example, the hemp fibers may be obtained through a strain called X-59. According to an example, the hemp fibers may be within a certain length and/or within a certain range of an average aspect ratio. For example, the average length of hemp fibers may be approximately about 0.3 inch to 1 inch long and may be prescreened to have an average aspect ratio in the range of from about 21 to about 26. According to an example, the hemp fibers may be cut or chopped to have an average length and/or an average diameter. For example, the fibers may be cut to have an average length of about 15 to 20 mm, with the fibers having an average diameter of about 20 to about 30 microns.

According to an example, the range of hemp concentration (wt. %), with respect to the weight of the biodegradable resin-hemp composite, may be 1% to 60%. At 1 wt. % hemp content, the composite started showing increased mechanical properties (tensile strength & elongation at break) and increased degree of crystallinity when compared to the neat composite. At 60 wt. % hemp fiber, the composite became overloaded with hemp fiber and the material lost flexibility properties. For example, at 30%-60 wt. % of hemp fiber, the distribution of hemp fiber within the polymeric matrix caused an over saturation of fiber to polymeric molecules; which caused a non-linear increase of mechanical properties and a non-linear increase of the screw speed (RPM), which caused a decrease in energy efficiencies since the screw in the extruder had to work harder to mix the composite. The unexpected result was observed at 5%-20%, at 5% the tensile strength unexpectedly increased to 55-58 MPa, the elastic modulus increased to 3500-3800 MPa and the degree of crystallinity increased to 75-77%. At 20%, the elastic modulus and degree of crystallinity was unexpectedly at its maximum values. At 5%-15%, the mechanical properties (tensile strength & elastic modulus) and degree of crystallinity unexpectedly increased linearly and at 15%-20%, the mechanical properties (tensile strength & elastic modulus) and degree of crystallinity unexpectedly increased nonlinearly.

One challenge with most biopolymers may have been their hydrophilic properties. In order for a biodegradable polymer to replace fossil fuel derived plastics, one main area is for competition is a field related to the food packaging. For example, in order to make an alternative to a petroleum based 8 oz. plastic cup or a semi-degradable 8 oz plastic cup made out of PLA, the material will need to be able to hold water containing liquid without permeating the solid surface (contact angle of 90° or higher), have relatively more rapid biodegradability (90-95%) and/or to have similar mechanical properties to a neat resin. The first specification that needs to be looked at is a parameter regarding hydrophilicity. An easy way to test for hydrophobic/hydrophilic properties on a surface is through analysis of water contact angle. Generally, if the water contact angle is larger than 90°, the solid surface is considered hydrophobic.

According to an example, the finer as the fibrous filler may be surface treated. The surface treatment may change, alter, adjust, increase and/or decrease a property of the fiber or the fiber surface. For example, the hemp fibers may be surface treated with sodium hydroxide. Depending on the concentration of the sodium hydroxide, a property For example, the hemp fibers may be surface treated with 10% (w/v) sodium hydroxide solution. 10% (w/v) sodium hydroxide solution may change the property of the fiber surface, with increased adhesive property to the polymer matrix based on the biodegradable plastics or the treated surface may facilitate fiber adhesion to the polymer matrix.

According to an example, the surface treatment of the fibrous filler may be involve a variety of surface treatment techniques, such as a chemical treatment, a mechanical treatment, a chemical infusion or permeation into the surface thereof, coating the surface or any combination thereof. For example, the fibrous filler may be mechanically surface treated by mercerization. For example, the mercerization may be carried out, to which the fibers were mixed with the chemical solution, such as sodium hydroxide solution. For example, the range of the surface energy of the fiber may be in the range of 30-60 mJ/m². For example, the range of the concentration of sodium hydroxide used to surface treat the fiber may be 1-20% (w/v). The purpose of surface treatment of fibers is to adjust the surface energy of the neat fiber (30-35 mJ/m²) to resemble the surface energy of the polymeric matrix; in this case the surface energy of the polymeric matrix (neat PHBV) is 40-45 mJ/m². At 30 mJ/m², 1% (w/v) sodium hydroxide is used to treat the fiber and at 60 mJ/m², 20% (w/v) sodium hydroxide is used to treat the fiber; both surface energy values do not closely match the surface energy of the polymeric matrix (40-45 mJ/m²). At 35 mJ/m², 5% (w/v) sodium hydroxide is used to treat the fiber and at 55 mJ/m², 15% (w/v) sodium hydroxide is used to treat the fiber; both surface energy values do not closely match the surface energy of the polymeric matrix (40-45 mJ/m²). Unexpectedly, when using a 10% (w/v) sodium hydroxide solution, the surface energy of the hemp fiber is in the range of 45-50 mJ/m²; which closely matches the range of the polymeric matrix (40-45 mJ/m²).

According to an example, the composite may contain beeswax, for example, as an agent for surface treatment, surface infusion, surface permeation, and/or surface coating of the fibrous filler. For example, beeswax may coat the surface of a fiber such as a hemp fiber. For example, the hemp fiber may be surface-treated, infused/surface-infused, permeated/surface-permeated, and/or coated/surface-coated by being wetted with wax emulsion emulsified with water or demineralized water emulsified wax (Beeswax) ratio of 2:1 (v/v), and maintaining a wetting ratio (g of emulsified wax:g of dry fiber) of 1:15, 1:16, 1:17, 1:18, or 1:19. Within these wetting ratios, lies the relatively more efficient surface treatment, infusion/surface-infusion, permeation/surface-permeation, and/or coating/surface coating of the hemp fiber surface.

A fossil fuel derived polymer, such as PP, PE, PS, PVC, has a contact angle of above 90° and exhibit a mechanical property that is considered sufficient for its application such as food packaging. However, a fossil fuel derived polymer, such as PP, PE, PS, and PVC is not considered biodegradable. According to an example, the wax treated, wax infused, wax permeated or wax coated fiber reinforced biopolymers, such as beeswax infused, beeswax treated, beeswax permeated, or beeswax coated, can have a contact angle of 90° or higher. For example, a biodegradable composite containing PHBV and a wax-treated hemp fiber in composition that is, for example, as disclosed in the present disclosure, has a contact angle of 90° or higher.

According to an example, a biodegradable composite containing a surface treated or surface infused or surface permeated or surface coated fiber may have a relatively increased contact angle with water compared to a composite containing a fiber that is not surface-treated. For example, a biodegradable composite containing a biodegradable fiber treated with hydrophobic material may have a relatively increased contact angle with water compared to a composite containing a fiber that is not surface-treated. For example, a biodegradable composite containing a biodegradable fiber treated with wax such as beeswax may have a relatively increased contact angle with water compared to a composite containing a fiber that is not surface-treated. For example, a biodegradable composite containing PHBV and a biodegradable fiber can have a contact angle equal to or larger than 90°. However, a composite including a semi-degradable polymer such as PLA along with a wax-treated biodegradable fiber may be able to achieve a contact angle equal to or larger than 90° but its semi-degradability may not be sufficient to be considered biodegradable, such as less than 60% within 180 days of being exposed to conditions to cause bio-degrading.

According to an example, the range of wax concentration used to surface-treat, infuse/surface-infuse, permeate/surface-permeate, or coat/surface coat the fiber may be in the range of 1-90% (by wt.). At wax concentration of 1%, the water contact angle started showing increased water contact angle. At 90% wax concentration, the fibers became over saturated with wax and effected extrusion processing conditions, which led to the composite not being able to be processed. For example, 2%-50%: at 2%, the water contact angle was at 85° and had an even surface-infused or coat of wax on the surface of the fiber. At 50%, the fibers unexpectedly became over infused or over saturated with wax and effected extrusion processing conditions, which led to the composite not being able to be processed. The unexpected result was from about 5% to about 25%. At about 5% the water contact angle unexpectedly increased to 90° and had an even coat of wax on the surface of the fiber. At 25%, the water contact angle increased to 120° and was unexpectedly at its maximum, while the fibers became over saturated with wax and effected extrusion processing conditions, which led to the composite not being able to be processed. From 7%-20%, the water contact angle increased to 115° and unexpectedly still showed signs of saturation; which lead to processing issues. From 5%-7%, the water contact angle increased to 90° and unexpectedly showed even distribution of the wax on the fiber.

Hereinafter, an example of experimentation based on the disclosure is described.

### Experimental Examples—PHBV+Hemp Fiber

For composite production, the hemp fibers were obtained through a strain called X59. The hemp fibers were approximately 1 inch long and were prescreened to have an average aspect ratio in the range of from about 21 to about 26. The hemp fibers are then cut or chopped cut to have an average length of from about 15 mm to about 20 mm, with the fibers having an average diameter of from about 20 to about 30 microns.

Eight examples with different formulations containing the neat PHBV resin and hemp fibers were prepared as indicated in the Table 1 below, for variable mass content of the hemp fiber filler in the polymer matrix 0 wt. % 1 wt. %, 3 wt. %, 5 wt. %, 10 wt. %, 15 wt. %, 20 wt. %, and 30 wt. % with the following designations: PHBV-H0%, PHBV-H1%, PHBV-H3%, PHBV-H 5%, PHBV-H 10%, PHBV-H 15%, PHBV-H20%, PHBV-H30%.

TABLE 1
Compositions (wt % of the composite) of
the Fiber Reinforced PHBV Composites

| | | Hemp | | | |
|---|---|---|---|---|---|
| | PHBV | Fiber | Fiber | Fiber | Hemp |
| Sample | (wt. %) | (wt. %) | length | Diameter | Strain |
| PHBV-H0% | 100 | 0 | N/A | N/A | N/A |
| PHBV-H1% | 99 | 1 | 15-20 mm | 20-30 microns | X-59 |
| PHBV-H3% | 97 | 3 | 15-20 mm | 20-30 microns | X-59 |
| PHBV-H5% | 95 | 5 | 15-20 mm | 20-30 microns | X-59 |
| PHBV-H10% | 90 | 10 | 15-20 mm | 20-30 microns | X-59 |
| PHBV-H15% | 85 | 15 | 15-20 mm | 20-30 microns | X-59 |
| PHBV-H20% | 80 | 20 | 15-20 mm | 20-30 microns | X-59 |
| PHBV-H30% | 70 | 30 | 15-20 mm | 20-30 microns | X-59 |

The examples with the formulations were then fused and made into composites using a single screw extruder. PHBV-hemp fiber composites of the examples were produced by an extrusion process using a ZAMAK EHP-25E single screw extruder. The PHBV-hemp fiber composites of the eight examples were produced based on the machine setting parameter presented in Table 2 below. The screw extruder was equipped with the four temperature controlled zones, i.e., Zone 1, Zone 2, Zone 3, and Feed Zone. Biocomposites were produced for variable mass content of the hemp fiber filler. PHBV-hemp fiber composites were produced by extrusion process using a ZAMAK EHP-25E single screw extruder. The machine setting parameters, for which the samples were produced, are presented in Table 2. The extruder had an initial, feed, section that begins the process of conveying solid polymeric material forward within the barrel of the extruder. An extruder may be used for a high-volume manufacturing process in which raw plastic and additives are blended and formed into a continuous profile. The screw extruder was equipped with the four temperature controlled zones, i.e.: Zone 1, Zone 2, Zone 3, and Feed Zone.

The Screw Length/Diameter ratio (“L/D ratio”) is the ratio of the flighted length of the screw to its outside diameter. The ratio calculation is calculated by dividing the flighted length of the screw by its nominal diameter. Diameter is the diameter of the screw used in the single screw extruder, for the proposed experiment. The temperature at the feed zone is the temperature within the feed hopper, before the material goes to Zone 1. The temperature at Zone 1 is the area below the feed zone and accounts for a third of the length of the barrel. This area is also called the feed zone. The temperature at Zone 2 is the area after Zone 1, where melting may occur mostly, for example, as the melting zone. In this area, the polymers melt and fibers may distribute within this melt. The temperature at Zone 3 is the area after Zone 2, as the melt pumping zone. In this area, the pressure from zone 2 builds up and pushes the material through the final Head Zone. The temperature of the head section is the temperature in the area between Zone 3 and the exit die.

TABLE 2
Single Screw Extruder Temperature Profile, Screw Speed and Screw
Dimensions with Respect to Fiber Reinforced PHBV Composites

| | Screw Length/ | | Head | | | | Feed | Screw |
|---|---|---|---|---|---|---|---|---|
| | Diameter | Diameter | Zone Temp. | Zone 1 | Zone 2 | Zone 3 | Zone | Speed |
| | (L/D ratio) | (mm) | (° C.) | (° C.) | (° C.) | (° C.) | (° C.) | (RPM) |
| PHBV-H0% | 34-36:1 | 25-27 | 160-165 | 135-140 | 145-150 | 155-160 | 30-32 | 90-100 |
| PHBV-H1% | 34-36:1 | 25-27 | 160-165 | 135-140 | 145-150 | 155-160 | 30-32 | 90-100 |
| PHBV-H3% | 34-36:1 | 25-27 | 165-170 | 140-145 | 150-155 | 160-165 | 30-32 | 90-100 |
| PHBV-H5% | 34-36:1 | 25-27 | 165-170 | 140-145 | 150-155 | 160-165 | 30-32 | 90-100 |
| PHBV-H10% | 34-36:1 | 25-27 | 170-175 | 145-150 | 155-160 | 165-170 | 30-32 | 90-100 |
| PHBV-H15% | 34-36:1 | 25-27 | 175-180 | 150-155 | 160-165 | 170-175 | 30-32 | 90-100 |
| PHBV-H20% | 34-36:1 | 25-27 | 175-180 | 150-155 | 160-165 | 170-175 | 30-32 | 90-100 |
| PHBV-H30% | 34-36:1 | 25-27 | 175-180 | 150-155 | 160-165 | 170-175 | 30-32 | 90-100 |

The composites were then produced into packaging materials in the form of 8 oz cups used injection molding based on the conditions presented in Table 3 below. The Dr Boy 55E injection molding machine was used for the injection molding process. Several 8 oz. cup samples were produced and tested for mechanical properties and surface properties. An 8 oz. mold was used to produce the 8 oz. cups.

TABLE 3
Processing Parameters of Injection Molding for Production of
8 oz. Cup with Respect to a Fiber Reinforced PHBV Composite

| | PHBV- | PHBV- | PHBV- | PHBV- | PHBV- | PHBV- | PHBV- |
|---|---|---|---|---|---|---|---|
| | H0% | H3% | H5% | H10% | H15% | H20% | H30% |
| Injection Speed | 30-35 | 30-35 | 30-35 | 30-35 | 30-35 | 30-35 | 30-35 |
| (cm³s⁻¹) | | | | | | | |
| Clamping | 25-30 | 25-30 | 25-30 | 25-30 | 25-30 | 25-30 | 25-30 |
| pressure (MPa) | | | | | | | |
| Clamping time (s) | 20-25 | 20-25 | 20-25 | 20-25 | 20-25 | 20-25 | 20-25 |
| Cooling time (s) | 20-25 | 20-25 | 20-25 | 20-25 | 20-25 | 20-25 | 20-25 |
| Melt | 160-162 | 162-165 | 165-167 | 168-170 | 173-175 | 175-178 | 178-180 |
| temperature (° C.) | | | | | | | |
| Mold | 50-55 | 50-55 | 55-60 | 70-75 | 75-80 | 85-90 | 85-90 |
| Temperature (° C.) | | | | | | | |

Material properties of the examples as raw materials, composites and finished product packaging were measured or analyzed, for example, via differential scanning calorimetry, The ZWICK Z030 universal testing machine, the BIOLIN SCIENTIFIC OPTICAL TENSIOMETER and a KRUSS SURFACE ANALYZER. The results of the measurements of analysis were indicated in Table 4 and Table 5.

TABLE 4
Mechanical, Thermal and Surface Properties of Materials Used in
Invention with Respect to Hemp Fiber Reinforced PHBV Composites

| | | | Degree | | |
|---|---|---|---|---|---|
| | Tensile | Elastic | of Crys- | Contact | Surface |
| | Strength | Modulus | tallinity | Angle | Energy |
| | (MPa) | (MPa) | (W_{c}, %) | (H₂O, °) | (mJ/m²) |
| Neat PHBV | 40-45 | 2800-3000 | 40-45% | 75-80 | 40-45 |
| Resin | | | | | |
| Neat Hemp | 800-900 | 4500-4800 | Not available | 35-40 | 30-35 |
| Fiber | | | | | |
| Surface | 800-900 | 4500-4800 | Not available | 35-40 | 45-50 |
| Treated | | | | | |
| Hemp Fiber | | | | | |
| PHBV-H1% | 40-45 | 2800-3000 | 40-45% | 60-65 | 45-50 |
| PHBV-H3% | 40-45 | 3000-3200 | 50-55% | 60-65 | 45-50 |
| PHBV-H5% | 55-58 | 3500-3800 | 75-77 | 50-55 | 45-50 |
| PHBV-H10% | 60-63 | 4200-4500 | 75-78 | 50-55 | 45-50 |
| PHBV-H15% | 65-68 | 4700-5000 | 75-79 | 50-55 | 45-50 |
| PHBV-H20% | 75-80 | 5000-5300 | 75-79% | 50-55 | 45-50 |
| PHBV-H30% | 85-90 | 5000-5300 | 75-79% | 50-55 | 45-50 |

TABLE 5
Mechanical and Surface Analysis of 8 oz. Cup Produced
With Respect to Fiber Reinforced PHBV

| | Tensile | Elastic | Contact | Surface |
|---|---|---|---|---|
| | Strength | Modulus | Angle | Energy |
| | (MPa) | (MPa) | (H₂O, θ) | (mJ/m²) |
| 8 oz. cup | 55-60 | 3000-3600 | 50-55 | 40-45 |
| (PHBV-H 0%) | | | | |
| 8 oz. cup | 55-60 | 3000-3600 | 50-55 | 50-55 |
| (PHBV-H 1%) | | | | |
| 8 oz. cup | 60-63 | 3600-3800 | 50-55 | 50-55 |
| (PHBV-H 5%) | | | | |
| 8 oz. cup | 63-65 | 4300-4500 | 50-55 | 50-55 |
| (PHBV-H 10%) | | | | |
| 8 oz. cup | 66-68 | 4800-5000 | 50-55 | 50-55 |
| (PHBV-H 15%) | | | | |
| 8 oz. cup | 75-80 | 5000-5300 | 50-55 | 50-55 |
| (PHBV-H20%) | | | | |
| 8 oz. cup | 85-90 | 5300-5500 | 50-55 | 50-55 |
| (PHBV-H 30%) | | | | |

The hemp fiber concentrations used in the examples were 0%, 1%, 5%, 10%, 15%, 20% and 30% by weight percent (wt %) with respect to the total weight of the biodegradable composite.

When hemp fiber was used as a reinforcement agent in a PHBV/fiber composite as a biodegradable composite, some mechanical properties improved in comparison to neat PHBV resin.

When the tensile strength was higher than 80 MPa, the material was too rigid. If a material is too rigid, it may limit its applications for being less versatile and can be specifically used for applications suitable for rigid materials and not elastic materials. The tensile strength of the neat PHBV resin is known to be between from about 40 MPa to about 45 MPa. With the addition of around about 1 wt. % to 3 wt. % hemp fiber with respect to the weight of the biodegradable composite, the tensile strength of the biodegradable composite stayed around from about 40 to about 45 MPa. With the addition of 5 wt. % of the hemp fiber with respect to the biodegradable composite weight, the tensile strength of the resin increased from about 40 MPa-about 45 MPa to from about 55 MPa to about 58 MPa. With the addition of 10 wt. % of the hemp fiber with respect to the biodegradable composite weight, the tensile strength of the resin increased from about 40 MPa-about 45 MPa to from about 60 MPa to about 63 MPa. With the addition of 15 wt. % of the hemp fiber with respect to the biodegradable composite weight, the tensile strength of the resin increased from about 40 MPa-about 45 MPa to from about 65 MPa to about 68 MPa. Composites were produced below the 5 wt. % minimum hemp fiber content with respect to the weight of the biodegradable composite. The composite with 3% hemp fiber by wt. (PHBV-H3%) had a negligible amount of tensile strength increased with respect to neat PHBV resin; both the neat PHBV resin and PHBV-H3% composite had a tensile strength of about 40 MPa about 45 MPa. The other composite with 1% hemp fiber by wt. (PHBV-H1%) had a negligible amount of tensile strength increase with respect to neat PHBV resin; both the neat PHBV resin and PHBV-H1% composite had a tensile strength of 40-45 MPa. Composites were produced above the 15% maximum hemp fiber content. One example composite with 20 wt. % with respect to the weight of the biodegradable composite (PHBV-H20%) had an unexpected jump in a tensile strength (from about 75 MPa to about 80 MPa), which would make the composite too rigid for certain applications. The other composite with 30 wt. % with respect to the weight of the biodegradable composite (PHBV-H30%) had too high of a tensile strength (from about 85 MPa to about 90 MPa), which would make the composite too rigid for more applications such certain packaging applications.

The elastic modulus of neat PHBV is known to be between about 2800 MPa-3000 MPa. With the addition of 5 wt. % hemp fiber with respect to the weight of the biodegradable composite, the elastic modulus of the resin increased from about 2800 MPa-about 3000 MPa to from about 3500 to about 3800 MPa. With the addition of 10 wt. % hemp fiber with respect to the weight of the biodegradable composite, the elastic modulus of the resin increased from 2800-3000 MPa to 4200-4500 MPa. With the addition of 15 wt. % hemp fiber with respect to the weight of the biodegradable composite, the elastic modulus of the resin increased from about 2800 MPa-about 3000 MPa to from about 4700 MPa to about 5000 MPa.

Both the elastic modulus and the tensile strength were measured with the ZWICK Z030 universal testing machine.

When the elastic modulus and the tensile strength of a composite is increased; the composite will have much more balance of durability and elasticity which will enable versatility

When hemp fiber was used as a reinforcement agent in a biodegradable composite (PHBV/fiber composite), some thermal characteristics improved in comparison to neat PHBV resin.

The heat of crystallinity of neat PHBV is known to be from about 40% to about 45%. With the addition of 5 wt. % hemp fiber with respect to the weight of the biodegradable composite, the heat of crystallinity of the resin increased from about 40%-about 45% to from about 74% to about 77%. With the addition of 10 wt. % hemp fiber with respect to the weight of the biodegradable composite, the heat of crystallinity of the resin increased from about 40%-about 45% to from about 75% to about 78%. With the addition of 15% wt. hemp fiber, the heat of crystallinity of the resin increased from about 40%-about 45% to from about 76% to about 79%.

When the heat of crystallinity of a composite is increased, this correlates to a more stable structure and a higher tensile strength value.

The heat of crystallinity was measured using a Q2000™ differential scanning calorimeter (DSC) from TA Instruments, Inc.

The surface energy of neat PHBV is known to be from about 40 mJ/m² to about 45 mJ/m². With the addition of the surface treated hemp fiber, the surface energy of the 5 wt. %, 10 wt. % and 15 wt. % hemp fiber composite increased from about 40 mJ/m²-about 45 mJ/m² to from about 45 mJ/m² to about 50 mJ/m².

Surface energy was measured with a BIOLIN SCIENTIFIC OPTICAL TENSIOMETER.

Despite the fiber increasing certain thermal and mechanical properties; the fiber does not increase the contact angle of the bio-composite by much. For the composite containing 5 wt. %, 10 wt. %, 15 wt. %, or higher than 15 wt. % hemp fiber as weight % with respect to the weight of the biodegradable composite; the contact angle was decreased from neat PHBV resin value (from about 75° to about 80°) to the composite value (from about 50° to about 55°).

Contact angles were analyzed using a KRUSS surface analyzer.

Finished cup material produced from the PHBV-H5%, H10%, and H15% composites were developed using injection molding, based on the processing parameters indicated in Table 3. The mechanical properties of the 8 oz cups produced from the PHBV-H5%, PHBV-H10%, PHBV-H15% resins were analyzed. The PHBV-H5% 8 oz. cup had a tensile strength of from about 60 MPa to about 63 MPa and an elastic modulus of from about 3600 MPa to about 3800 MPa. If the tensile strength goes below the 60 MPa value or if the elastic modulus goes below the 3600 MPa value, or in other words any hemp fiber concentration below 5% (PHBV-H0%, PHBV-H1%, and PHBV-H3%), the 8 oz. cup would be too structurally weak and would effects its versatility. The PHBV-H10% 8 oz. cup had a tensile strength of from about 63 MPa 65 MPa and an elastic modulus of from about 4300 MPa to about 4500 MPa. The PHBV-H15% 8 oz. cup had a tensile strength of from about 66 MPa to about 68 MPa and an elastic modulus of from about 4800 MPa to about 5000 MPa. If the tensile strength goes above the 66 MPa value or if the elastic modulus goes above the 5000 MPa value, or in other words any hemp fiber concentration above 20% (PHBV-H20%, PHBV-H25%, and PHBV-H30%), the 8 oz. cup would be too structurally strong and would affect its versatility.

Both the elastic modulus and the tensile strength were measured with the ZWICK Z030 universal testing machine.

The surface properties of the 8 oz. cups produced from the PHBV-H5%, PHBV-H10%, PHBV-H15% resins were analyzed for water contact angles. The PHBV-H5%, PHBV-H10% and the PHBV-H15% 8 oz. cups had a water contact angle of from about 50° to about 55°. These contact angle indicated that the surfaces of these cups are relatively too hydrophilic to be used for applications to store hydrophilic liquid such as water. With such relatively low water contact angles; these cups would not be viable for long term storage of hydrophilic liquids. These relatively low water contact angle indicate that these biodegradable composites may be used for applications to store non-hydrophilic liquid such as oil.

In order to produce a resin composite that is relatively more resistant to water absorption for hydrophilic liquid storage applications; the contact angle will need to be increased to from about 85° to about 90° or higher.

### Experimental Examples—PHBV+Hemp Fiber+Wax

For composite production, the hemp fibers were obtained through a strain called X-59. The hemp fibers were approximately 1 inch long and were prescreened to have an average aspect ratio in the range of from about 21 to about 26. The hemp fibers are then cut or chopped cut to have an average length of from about 15 mm to about 20 mm, with the fibers having an average diameter of from about 20 to about 30 microns.

Prior to composite production, the hemp fibers were surface treated with 10%-15% sodium hydroxide solution to improve fiber adhesion to the polymer matrix. The mercerization was carried out for 1 hour in a rotor device, to which the fibers were mixed with the 10% sodium hydroxide solution. The fibers were then washed with water until neutral pH (pH 7-7.5) and filtered off using a centrifuge and dried at 90-100° C. to dryness, then sieved.

The hemp fiber used in this experiment had an average diameter of from about 20 microns to about 30 microns and a length of from about 15 mm to about 20 mm.

The infusing or the coating of the hemp fibers was carried out by mixing a batch of the fibers (1000 g) with a dilute emulsion of wax in deionized water.

The wax to water ratio was about 1:1 (volume/volume) for the emulsion and the wax to fiber ratio was about 1:18. 55 grams of beeswax was mixed with 55 mL of water; which is then mixed with 1000 grams of hemp fiber into a 24 L batch mixer; mixed at about 60° C. to about 65° C. and 100 RPM.

The infused or coated fiber was kept in a ventilated, oven at 120° C. for 42 hour.

The surface treatment of the dried hemp fibers with beeswax was carried out by wetting the hemp fibers with a dilute emulsion of wax in demineralized water: emulsified wax (beeswax) to water ratio of about 2:1 (v/v). A wetting ratio (the amount of the emulsified wax:the amount of dried hemp fiber) was maintained at about 1:18. The wetting process was conducted in knives blender operating at high speed, slowly injecting the emulsion of wax.

The wetted hemp fiber was kept in a ventilated oven at 120° C. for 42 hour, and then processed with PHBV in a single-screw extruder with a single screw in a barrel system, for producing granules of the composites containing PHBV, fiber and wax (e.g., PHBV/fiber/wax composite) in different compositions. In processing the wetted hemp fiber with PHBV, PHBV granules were fed by the main hopper and the wetted hemp fibers with the wax emulsion (treated with wax) were fed by a side hopper. The temperature profile (° C.) adopted for the composites is shown in Table 6. The exit strands were cooled in cold water bath and dried by a constant jet of air and, then, pelletized in a mechanical cutter. The resultant granules were dried for 8 h in a dryer at 45° C.

In these examples, five types of composite resins were be produced, which contain hemp fiber infused or coated with different concentrations of beeswax (0.28 wt. %, 0.056 wt. %, 0.83 wt. %, 1.11 wt. %, and 1.69 wt. %, with respect to the weight of the biodegradable composite). The three composites had different hemp content (5 wt. %, 10 wt. %, 15 wt. %, 20 wt. % and 30 wt. %, with respect to the weight of the biodegradable composite). Refer to Table 1 for hemp fiber content with respect to the fiber reinforced PHBV composite.

Five different formulations containing the neat PHBV resin and beeswax infused hemp fibers were produced as shown in Table 6 below.

TABLE 6
Composition of Wax Infused Hemp
Fiber Reinforced PHBV Composite

| | PHBV | Hemp Fiber | Beeswax |
|---|---|---|---|
| Sample | (wt. %) | (wt. %) | (wt. %) |
| PHBV-H5% W1 | 94.72 | 5 | .28 |
| PHBV-H10% W2 | 89.44 | 10 | .56 |
| PHBV-H15% W3 | 84.17 | 15 | .83 |
| PHBV-H20% W4 | 79% | 20% | 1.11% |
| PHBV-H30% W5 | 68.31% | 30% | 1.69% |

The formulations were then made into composites using a single screw extruder (Table 7).

TABLE 7
Single Screw Extruder Temperature Profile, Screw Speed and Screw Dimensions
with Respect to Beeswax Infused Fiber Reinforced PHBV Composites

| | Screw Length/ | Screw | Head | | | | Feed | Screw |
|---|---|---|---|---|---|---|---|---|
| | diameter | Diameter | Zone | Zone 1 | Zone 2 | Zone 3 | Zone | Speed |
| | (ratio) | (mm) | (° C.) | (° C.) | (° C.) | (° C.) | (° C.) | (RPM) |
| PHBV-H5% W1 | 35-37:1 | 26-28 | 160-165 | 135-140 | 145-150 | 155-160 | 31-33 | 100-110 |
| PHBV-H10% W2 | 35-37:1 | 26-28 | 165-170 | 140-145 | 150-155 | 160-165 | 31-33 | 100-110 |
| PHBV-H15% W3 | 35-37:1 | 26-28 | 170-175 | 145-150 | 155-160 | 165-170 | 31-33 | 100-110 |
| PHBV-H20% W4 | 35-37:1 | 26-28 | 175-180 | 150-155 | 160-165 | 170-175 | 31-33 | 100-100 |
| PHBV-H30% W5 | 35-37:1 | 26-28 | 175-180 | 150-155 | 160-165 | 170-175 | 31-33 | 100-100 |

The composites were then produced into packaging materials in the form of 8 oz cups using injection molding (Table 8).

TABLE 8
Processing Parameters of Injection Molding for Production of 8
oz. Cup with Respect to a Beeswax Infused Fiber Reinforced PHBV

| | PHBV- | PHBV- | PHBV- | PHBV- | PHBV- |
|---|---|---|---|---|---|
| | H5% W1 | H10% W2 | H15% W3 | H20% W4 | H30% W5 |
| Injection | 32-37 | 32-37 | 32-37 | 32-37 | 32-27 |
| Speed | | | | | |
| (cm³s⁻¹) | | | | | |
| Clamping | 27-32 | 27-32 | 27-32 | 32-35 | 32-35 |
| pressure | | | | | |
| (MPa) | | | | | |
| Clamping | 23-27 | 23-27 | 23-27 | 23-27 | 23-27 |
| time (s) | | | | | |

Five types of composite resins were produced, which contain hemp fiber infused or coated with different concentrations of beeswax (0.28 wt. %, 0.56 wt. %, 0.83 wt. %, 1.11 wt. %, and 1.69 wt. %, with respect to the weight of the biodegradable composite). The five composites had different hemp content (5 wt. %, 10 wt. %, 15 wt. %, 20 wt. % and 30 wt. % with respect to the weight of the biodegradable composite). With the following designations: PHBV-H5% W1, PHBV-H10% W2, PHBV-H15% W3, PHBV-H20% W4 and PHBV-H30% W5. PHBV-hemp fiber composites were produced by extrusion process using a ZAMAK EHP-25E single screw extruder. The machine temperature setting parameters, for which the samples were produced, are presented in Table 8. The screw extruder was equipped with the four temperature-controlled zones, i.e.: zone 1, zone 2, zone 3, and feed zone.

The DR BOY 55E injection molding machine was used for the injection molding process. Several 8 oz. cup samples were produced and tested for mechanical properties and surface properties.

The machine setting parameters, for which the samples were produced, are presented in Table 9. An 8 oz. mold was used to produce the 8 oz. cups.

All raw materials, composites and finished product packaging were analyzed (Table 9 and Table 10) using a Q2000™ TA INSTRUMENTS DIFFERENTIAL SCANNING CALORIMETER, THE ZWICK Z030 UNIVERSAL TESTING MACHINE, THE BIOLIN SCIENTIFIC OPTICAL TENSIOMETER AND A KRUSS SURFACE ANALYZER.

TABLE 9
Mechanical, Thermal and Contact Angle Properties of
Materials Used in Invention with Respect to Beeswax
Infused Hemp Fiber Reinforced PHBV Composites

| | | | Degree | | |
|---|---|---|---|---|---|
| | Tensile | Elastic | of Crys- | Contact | Surface |
| | Strength | Modulus | tallinity | Angle | Energy |
| | (MPa) | (MPa) | (W_{c}, %) | (H₂O, °) | (mJ/m²) |
| Beeswax | N/A(not | N/A | N/A | 105-110 | N/A |
| | available) | | | | |
| Neat Hemp | 800-900 | 4500-4800 | N/A | 35-40 | 30-35 |
| Fiber (surface | | | | | |
| treated) | | | | | |
| Hemp Fiber | 850-900 | 4600-4900 | N/A | 105-110 | 45-50 |
| infused with | | | | | |
| Beeswax | | | | | |
| PHBV-H5% W1 | 57-60 | 3700-3900 | 74-76 | 90-95 | 45-50 |
| PHBV-H10% W2 | 60-63 | 4000-4200 | 74-77 | 90-95 | 45-50 |
| PHBV-H15% W3 | 60-66 | 4300-4500 | 74-78 | 90-95 | 45-50 |
| PHBV-H20% W4 | 70-75 | 5000-5300 | 75-79 | 90-95 | 45-50 |
| PHBV-30% W5 | 75-80 | 5000-5300 | 75-79 | 90-95 | 45-50 |

TABLE 10
Mechanical and Surface Analysis of 8 oz. Cup Produced
With Respect to Beeswax Infused Fiber Reinforced PHBV

| | Tensile | Elastic | Contact | Surface |
|---|---|---|---|---|
| | Strength | Modulus | Angle | Energy |
| | (MPa) | (MPa) | (H₂O, °) | (mJ/m²) |
| 8 oz cup. | 61-64 | 3800-4000 | 90-95 | 50-55 |
| (PHBV-H5% W1) | | | | |
| 8 oz. cup | 64-67 | 4000-4300 | 90-95 | 50-55 |
| (PHBV-H10% W2) | | | | |
| 8 oz. cup | 66-69 | 4300-4600 | 90-95 | 50-55 |
| (PHBV-H15% W3) | | | | |
| 8 oz. cup | 75-80 | 5000-5300 | 90-95 | 50-55 |
| (PHBV-H20% W4) | | | | |
| 8 oz. cup | 85-90 | 5000-5300 | 90-95 | 50-55 |
| (PHBV-H30% W5) | | | | |

When hemp fiber infused or coated with beeswax is used as a reinforcement agent in a PHBV/fiber composite, certain thermal characteristics improve in comparison to neat PHBV.

The heat of crystallinity of neat PHBV is known to be between 40-45%. With the addition of 5 wt. % hemp fiber infused or coated with beeswax (0.28 wt. %), the heat of crystallinity increases from 40-45% to 74-76%. With the addition of 10 wt. % hemp fiber coated with beeswax (0.56 wt. %), the heat of crystallinity increases from 40-45% to 74-77%. With the addition of 15% wt. hemp fiber infused or coated with beeswax (0.83 wt. %), the heat of crystallinity increases from 40-45% to 74-78%.

Accordingly, the experimental results showed that the bee wax coating of the hemp fibers included in the biodegradability resin significantly increased the heat of crystallinity. When the heat of crystallinity of a composite is increased, this factor correlates to a more stable structure and a higher tensile strength value.

The heat of crystallinity was measured using a Q2000™ differential scanning calorimeter (DSC) from TA Instruments, Inc.

When hemp fiber infused or coated with beeswax was used as a reinforcement agent in a PHBV/fiber composite, some mechanical properties improved in comparison to neat PHBV.

The tensile strength of neat PHBV is known to be between 40-45 MPa. With the addition of 5 wt. % hemp fiber infused or coated with beeswax (0.28 wt. %), the tensile strength of the composite increases from 40-45 MPa to 57-60 MPa. With the addition of 10 wt. % hemp fiber infused or coated with beeswax (0.56 wt. %), the tensile strength of the composite increases from about 40 MPa to about 45 MPa to from about 60 MPa to about 63 MPa. With the addition of 15 wt. % hemp fiber infused or coated with beeswax (0.83 wt. %), the tensile strength of the composite increased from about 40 MPa to about 45 MPa to from about 60 MPa to about 66 MPa.

The elastic modulus of neat PHBV is known to be between 2800-3000 MPa. With the addition of 5 wt. % hemp fiber infused or coated with beeswax (0.28 wt. %), the elastic modulus increased from about 2800 MPa-about 3000 MPa to about 3700 MPa to about 3900 MPa. With the addition of 10 wt. % hemp fiber infused or coated with beeswax (0.56 wt. %), the elastic modulus increased from about 2800 MPa-about 3000 MPa to about 4000 MPa-about 4200 MPa. With the addition of 15 wt. % hemp fiber infused or coated with beeswax (0.83 wt. %), the elastic modulus increased from about 2800 MPa-about 3000 MPa to about 4300 MPa-about 4500 MPa.

Both the elastic modulus and the tensile strength were measured with The Zwick Z030 universal testing machine.

When the elastic modulus and the tensile strength of a composite is increased; this generally creates a more viable resin to be used in commercial end products such as 8 oz. cups.

The surface energy of neat PHBV is known to be 40-45 mJ/m². With the addition of the surface treated, beeswax infused or coated hemp fiber; the surface energy of the 5 wt. %, 10 wt. % and 15 wt. % hemp fiber composite infused or coated with beeswax (0.28 wt. %, 0.56 wt. %, 0.83 wt. %) increased from 40-45 mJ/m² to 45-40 mJ/m².

The contact angle of neat PHBV is known to be about 75°-about 80°. With the addition of the surface treated, beeswax infused or coated hemp fiber; the contact angles of the 5 wt. %, 10 wt. % and 15 wt. % hemp fiber composite infused or coated with beeswax (0.28 wt. %, 0.56 wt. %, 0.83 wt. %) increased from about 75°-about 80° to about 90°-about 95°.

This increase of contact angle is significant for future use of this resin with respect to production of 8 oz. cups. The uncoated/uninfused hemp fiber PHBV composite had an increased tensile strength and elastic modulus values but had a decreased contact angle. The beeswax infused or coated hemp fiber PHBV composite had an increased tensile strength and elastic modulus and an increased contact angle. The biodegradable composite with both an increase in both tensile strength and elastic modulus and an increase in the contact angle is significant result for development of consumer packaging, because, without a high contact angle, the packaging will not be commercially viable for hydrophilic liquid contact.

The mechanical properties of the 8 oz cups produced from the PHBV-H5% W1, PHBV-H10% W2, PHBV-H15% W3 resins were analyzed. The PHBV-H5% W1 8 oz. cup had a tensile strength of about 61 MPa-about 64 MPa and an elastic modulus of about 3800 MPa-about 4000 MPa. The PHBV-H10% W2 8 oz. cup had a tensile strength of about 64 MPa-about 67 MPa and an elastic modulus of about 4000 MPa-about 4300 MPa. The PHBV-H15% W3 8 oz. cup had a tensile strength of about 66 MPa-69 MPa and an elastic modulus of about 4300 MPa-about 4600 MPa.

Both the elastic modulus and the tensile strength were measured with The Zwick Z030 universal testing machine.

The surface properties of the 8 oz. cups produced from the PHBV-H5% W1, PHBV-H10% W2, PHBV-H15% W3 resins were analyzed for contact angles. The PHBV-H5% W1, PHBV-H10% W2 and the PHBV-H15% W3 8 oz. cups had contact angles of about 90°-about 95°

Contact angles were analyzed using a KRUSS surface analyzer.

When beeswax (5 wt. %) is used to coat hemp fiber, certain mechanical properties were increased with respect to neat hemp fiber.

The tensile strength for neat hemp fiber is known to be about 800 MPa-about 900 MPa. With the addition of beeswax (5 wt. %) to the fiber, tensile strength increased to about 850-900 MPa.

The elastic modulus for neat hemp fiber is known to be 4500-4800 MPa. With the addition of beeswax (5 wt. %) to the fiber, elastic modulus increases to about 4600 MPa-about 4900 MPa.

When beeswax (5 wt. %) is used to coat hemp fiber, the contact angle increases substantially.

The contact angle for neat hemp fiber is known to be about 35°-about 40°. With the addition of beeswax (5 wt. %) is used to coat hemp fiber, the contact angle increases to about 105°-about 110°.

Contact angles were analyzed using a KRUSS surface analyzer.

### Biodegradability Test of Experimental Examples

In the experimental examples of this disclosure, the ASTM 6400 standard was used to test for compostability in a lab setting. This may be in view if the US markets but with a higher requirement of 90% threshold.

In order to be identified as compostable in municipal or industrial aerobic facilities via ASTM D6400-19, a product is to pass the three different requirements-disintegration during composting, biodegradation and a quality of compost test—using the appropriate laboratory tests which represent conditions found in an aerobic composting facility.

For example, for the first requirement, in summary, as a disintegration test, starting with the different varieties of a biodegradable plastic product such as the 8 oz cup—such as the experimental examples of the disclosure (PHBV-H5% W1, PHBV-H10% W2, PHBV-H15% W3, PHBV-H20% W4, PHBV-H30% W5) —its product pieces cut to 2 cm in length, in 180 days of composting under laboratory controlled composting conditions, 90% (90% in the experimental examples of the disclosure) of the product is to pass a 2 mm sieve, to be considered 90% biodegradable (or 90% biodegradable).

For example, for the second requirement, in summary, as a biodegradation test, ASTM D6400-19 states that 60% of the organic carbon is to be converted to carbon dioxide by the end of the test period, when compared to the positive control (cellulose).

For example, for the third requirement, in summary, as a compost quality test, with respect to plant growth, the germination rate and the plant biomass of the sample composts shall be no less than 90% that of the corresponding blank composts for two different plant species. Moreover, the section two of ASTM D6400-19 states that heavy metal concentrations is to be below a certain threshold.

In testing the experimental examples of this disclosure, disintegration, biodegradability and compost quality based on the ASTM D6400-19 standard to meet the compostability criteria as stated by ASTM D6400-19. A temperature controlled incubator capable of holding its temperature at 60° Cover the length of the test procedure was used. Cylindrical composting vessels with a volume of 7.5 liter (L) was also used. The containers have two sections separated by a porous pad so the top section has 6 L of free volume. 1 L of water is placed in the bottom section and the test material (inoculum plus testing material) was placed on top.

A 3 month old stable compost from a local compost facility is used for the inoculum. The compost was sieved through a 9.5 sieve and then mixed. Ammonium chloride was added so that the C/N (carbon/nitrogen) ratio is less than 15, and the appropriate amount of water to bring the moisture content to 50%.

The disintegration and biodegradation tests were tested separately, but in the same incubator. The tests started off with 200 g of 2 cm×2 cm squares of each the 8 oz. cup product formulation (PHBV-H5% W1, PHBV-H10% W2, PHBV-H15% W3, PHBV-H20% W4, PHBV-H30% W5) being tested and add it to 1200 g of compost and put the mixture in the composting vessels (top section). The mixture was composted for 180 days at 58 C. The composting vessel was shaken weekly to mix the sample & compost and to prevent extensive channeling, provide uniform attack on the test specimen, and provide an even distribution of moisture. At the end of 12 weeks material is emptied from the composting vessels and screened through a 2 mm sieve. In order to pass this test, no more than 10% of the original dry weight of the product can be retained on the sieve.

The biodegradation testing was conducted in triplicate on each of the following:

1.) the sample (100 g of sample+600 g dry weight of compost),

2.) positive control (100 g of cellulose+600 g dry weight of compost),

3.) negative control (100 g of polyethylene+600 g dry weight of compost), and

4.) blank (600 g dry weight of compost).

The moisture content of the mixtures was adjusted to 50%, then they are put into the composting vessels. The composting vessels are placed in the incubator at 58° C. The CO₂ free air is then connected and adjusted so that the flow rate is between 150 and 200 ml per minute. The gases exiting the test chambers were plumbed to a solenoid valve which is controlled to divert air for 2 minutes out of every 2 hours. These diverted gases flew into 1 liter adsorption units containing a known volume of 1N sodium hydroxide to adsorb the carbon dioxide being produced in the vessels (for the remainder to the 2 hours the exhaust is simply vented to the room). The sodium hydroxide is periodically titrated to measure the CO₂ production. As an example, standard days for the titration were 3, 7, 14, and every 7 days after that. It was titrated to pH 8.5 with 0.5N HCl after adding BaCl₂ to precipitate the carbonates formed by the CO₂. Fresh 1N sodium hydroxide is placed in the absorption units and the whole process is repeated. The testing is carried out until the CO₂ production from both the sample and the positive control have plateaued up to a maximum of 180 days.

For the plant growth study (compost quality), The pots used were cups with clear plastic covers, which holds in moisture, thus reducing the need to water which could lead to leaching of phytotoxins out of the material being tested. Several dilutions were made by diluting the sample with vermiculite; the same dilutions were also conducted on the positive control (cellulose). The dilutions were performed because compost was not a good a potting mix due to excess salts and excess nutrients. Triplicates of each dilution were made and were seeded. The highest concentration of the control that produced healthy plants was used for interpreting the results. 500 mg of seeds (corn and cucumber seeds were used) was planted into each cup. A plant density scale was developed using 0, 100, 200, 300, 400, and 500 mg of seeds in a series of cups and given an index of 0, 1, 2, 3, 4, and 5 respectively to be used in determining percent germination. The index value of the control was considered 100 percent germination when determining the index of the sample. Biomass is based on average height of healthy plants.

According to an example, a container may comprise a biodegradable composite forming at least a portion of the container. The biodegradable composite may include a biodegradable plastic polymer having a biodegradability of from about 80 percent (%) to about 95 percent (%) when measured according to a biodegradation test of an ASTM D6400-19 biodegradability standard, wherein a polymeric matrix of the biodegradable plastic polymer has a tensile strength of from about 30 MPa to about 45 MPa and an elastic modulus of from about 2600 MPa to about 3600 MPa. According to an example, the biodegradable composite may include a biodegradable fiber having a tensile strength greater than the tensile strength of the polymeric matrix of the biodegradable plastic polymer and an elastic modulus greater than the elastic modulus of the polymeric matrix.

The following will describe the results of the biodegradability tests on the experimental examples in this disclosure based on the experimental study. The experimental examples passed the disintegration test: 93% of the sample passed the 2 mm sieve after 12 weeks of composting. The experimental examples passed the biodegradation test: It took 118 days for 74% of the organic carbon in the material being tested to be converted to carbon dioxide when compared to the positive control (cellulose), thus meeting the standard of 60% or 90% within 180 days. It took 143 days for 93% of the organic carbon in the material being tested to be converted to carbon dioxide when compared to the positive control (cellulose). The testing was stopped after 175 days, the cumulative carbon dioxide production was 100% and thus plateaued. The experimental examples passed the plant growth test; Corn showed 100% emergence and 112% biomass; cucumber showed 99% emergence and 93% biomass. The third party heavy metal analysis also passed concentration acceptance standards. The products met the requirements to be considered “compostable” as judged by the United States standard ASTM D 6400.

According to an example, as seen as the Table 11 below; the fossil fuel derived polymers (PP, PE, PS, PVC) have a contact angle of above 90° and mechanical properties listed in Table 11. However the fossil fuel derived polymers are not biodegradable, for example, under the ASTM D6400-19 standard. The beeswax coated fiber reinforced biopolymers that have a contact angle of 90° or higher were PHBV-H15% W3, PLA-H15% W3 and PCL-H15% W3. These blend the respective neat polymers with 15 wt. % beeswax (0.83 wt. %) coated hemp fiber. A biodegradation test was described in the disclosure above for the PHBV-HW blends, in accordance to the ASTM D6400-19 standard, which states that biodegradation is the % of carbon in the material that gets converted into carbon dioxide within 180 days, compared to the positive control (cellulose). For example, in the experiments shown below, PLA-H15% W3 had the appropriate contact angle)(>90° and a high tensile strength, but its biodegradability was 15%-20% in 180 days according to the ASTM D6400-19 standard, which was relatively low compared to PHBV-H15% W3. PCL-H15% W3 also had the appropriate contact angle)(>90° and mechanical properties, but its biodegradability was 5%-15% in 180 days under the ASTM D6400-19 standard, which was relatively low to be effective under the ASTM D6400-19 standard. PHBV-H15% W3 had the highest biodegradability (90%-95% in 180 days) and best mechanical properties (65-68 MPa) out of the PHBV-H15% W3, PLA-H15% W3 and PCL-H15% W3 group; while also having a contact angle greater than 90°

TABLE 11
Comparison of Surface Treated Hemp Fiber Reinforced PHBV Composite
Resin, Biodegradable Plastic Polymer, and Fossil Fueled Plastics

| | | | | | Biodegradability |
|---|---|---|---|---|---|
| | | | | | test in accordance |
| | Tensile | Elastic | Degree of | Contact | with the ASTM |
| | Strength | Modulus | Crystallinity | Angle | D6400 - 19 standard |
| | (MPa) | (MPa) | (W_{c}, %) | (H₂O, °) | (180 days, %) |
| PHBV-H15% | 65-68 | 4700-5000 | 75-79 | 50-55 | 90%-95% |
| PHBV-H15% W3 | 60-66 | 4300-4500 | 74-78 | 90-95 | 85%-90% |
| PLA-H15% | 50-55 | 4000-4300 | 40-45 | 50-55 | 20%-25% |
| PLA-H15% W3 | 45-50 | 3600-4000 | 40-45 | 90-95 | 15%-20% |
| TPS-H15% | 10-15 | 200-250 | 20-25 | 40-45 | 90%-95% |
| TPS-H15% W3 | 5-10 | 150-300 | 20-25 | 80-85 | 90%-95% |
| PCL-H15% | 35-40 | 800-900 | 50-55 | 90-95 | 10%-20% |
| PCL-H15% W3 | 30-35 | 750-800 | 50-55 | 110-115 | 5%-15% |
| PBS-H15% | 40-45 | 100-150 | 45-50 | 60-65 | 80-85% |
| PBS-H15% W3 | 35-40 | 75-125 | 45-50 | 75-80 | 75-80% |
| PP-H15% | 55-60 | 1500-1800 | 40-45 | 90-95 | 0% |
| PP-H15% W3 | 50-55 | 1200-1599 | 40-45 | 115-120 | 0% |
| PE-H15% | 40-45 | 1400-1800 | 50-55 | 95-100 | 0% |
| PE-H15% W3 | 35-40 | 1200-1500 | 50-55 | 105-110 | 0% |
| PS-H15% | 50-55 | 2000-2400 | 60-65 | 95-100 | 0% |
| PS-H15% W3 | 45-50 | 1800-2200 | 60-65 | 105-110 | 0% |
| PVC-H15% | 50-55 | 1200-1500 | 60-65 | 100-105 | 0% |
| PVC-H15% W3 | 45-50 | 1000-1300 | 60-65 | 110-115 | 0% |

While various examples have been described with reference to the drawings, it will be understood that various changes in form and details may be made therein without departing from the spirit and scope as defined by the following claims.

What is claimed is:

1. A container comprising:
a biodegradable composite forming at least a portion of the container, the biodegradable composite including:
a biodegradable plastic polymer having a biodegradability of from about 80 percent (%) to about 95% when measured according to a biodegradability test in accordance with an ASTM D6400-19 standard, wherein a polymeric matrix of the biodegradable plastic polymer has a tensile strength of from about 30 MPa to about 45 MPa and an elastic modulus of from about 2600 MPa to about 3600 MPa; and
a bio-derived fiber infused with a bio-derived wax to have a surface energy of from about 45 mJ/m² to about 50 mJ/m², the bio-derived fiber having:
an average diameter of from about 20 microns to about 30 microns,
an average length of from about 15 mm to about 20 mm, and
a tensile strength greater than the tensile strength of the polymeric matrix of the biodegradable plastic polymer and an elastic modulus greater than the elastic modulus of the polymeric matrix.

2. The container according to claim 1, wherein the biodegradable composite has a tensile strength greater than about 45 MPa.

3. The container according to claim 1, wherein the biodegradable composite has an elastic modulus greater than about 3600 MPa.

4. The container according to claim 1, wherein the biodegradable plastic polymer includes at least one selected from a group comprising or consisting of poly-3-hydroxybutyrate (“P3HB”), poly-4-hydroxybutyrate (“P4HB”), poly 3-hydroxybutyrate-co-4-hydroxybutyrate (“P3HB-co-4HB”), poly-3-hydroxybutyrate-co-3-hydroxyvalerate (“PHBV”), poly-3-hydroxybutyratehexanoate (“PBHH”), polylactic acid (“PLA”), thermoplastic starch (“TPS”), poly-caprolactone (“PCL”), polybutylene succinate (“PBS”), polyglycolic acid (“PGA”), poly(lactic-co-glycolic acid) (“PLGA”), polybutylene adipate terephthalate (“PBAT”) and polyvinyl alcohol (“PVA”).

5. The container according to claim 1, wherein the biodegradable plastic polymer includes poly-3-hydroxybutyrate-co-3-hydroxyvalerate (“PHBV”).

6. The container according to claim 1, wherein the bio-derived fiber includes at least one selected from a group comprising or consisting of flax fiber, hemp fiber, ramie fiber, jute fiber, abaca fiber, cantala fiber, henequen fiber, sisal fiber, pineapple fiber, mitsumata fiber, gampi fiber, and kozo fiber.

7. The container according to claim 1, wherein the bio-derived fiber infused with the bio-derived wax includes a hemp fiber.

8. The container according to claim 7, wherein
the biodegradable plastic polymer includes poly-3-hydroxybutyrate-co-3-hydroxyvalerate (“PHBV”); and
an amount of the hemp fiber in the biodegradable composite is about 5 weight percent (wt. %) or more of the hemp fiber with respect to a weight of the biodegradable plastic composite and about 30 wt. % or less of the hemp fiber with respect to a weight of the biodegradable plastic composite.

9. The container according to claim 1, wherein the bio-derived wax includes beeswax.

10. The container according to claim 1, where the biodegradable composite exhibits a water contact angle equal to or greater than about 90°.

11. A biodegradable composite comprising:
a biodegradable plastic polymer having a biodegradability of from about 80 to 95 percent (%) within 180 days when measured according to a biodegradability test in accordance with an ASTM D6400-19 standard, wherein a polymeric matrix of the biodegradable plastic polymer has a tensile strength of about 30 MPa to about 45 MPa and an elastic modulus of from about 2600 MPa to about 3600 MPa; and
a bio-derived fiber infused with a bio-derived wax to have a surface energy of from about 45 mJ/m² to about 50 mJ/m², the bio-derived fiber having:
an average diameter of from about 20 microns to about 30 microns,
an average length of from about 15 mm to about 20 mm, and
a tensile strength greater than the tensile strength of the polymeric matrix of the biodegradable plastic polymer and an elastic modulus greater than the elastic modulus of the polymeric matrix.

12. The biodegradable composite according to claim 11, wherein
the biodegradable composite has a tensile strength greater than about 45 MPa, and
the biodegradable plastic composite exhibits a water contact angle equal to or greater than about 90°.

13. The biodegradable composite according to claim 11, wherein,
the biodegradable plastic polymer includes at least one selected from a group comprising or consisting of poly-3-hydroxybutyrate (“P3HB”), poly-4-hydroxybutyrate (“P4HB”), poly 3-hydroxybutyrate-co-4-hydroxybutyrate (“P3HB-co-4HB”), poly-3-hydroxybutyrate-co-3-hydroxyvalerate (“PHBV”), poly-3-hydroxybutyratehexanoate (“PBHH”), polylactic acid (“PLA”), thermoplastic starch (“TPS”), poly-caprolactone (“PCL”), polybutylene succinate (“PBS”), polyglycolic acid (“PGA”), poly(lactic-co-glycolic acid) (“PLGA”), polybutylene adipate terephthalate (“PBAT”) and polyvinyl alcohol (“PVA”), and
the biodegradable fiber includes at least one selected from a group comprising or consisting of flax fiber, hemp fiber, ramie fiber, jute fiber, abaca fiber, cantala fiber, henequen fiber, sisal fiber, pineapple fiber, mitsumata fiber, gampi fiber, and kozo fiber.

14. The biodegradable composite according to claim 11, wherein
the biodegradable plastic polymer includes poly-3-hydroxybutyrate-co-3-hydroxyvalerate (“PHBV”); and
an amount of the hemp fiber in the biodegradable composite is about 5 weight percent (wt. %) or more of the hemp fiber with respect to a weight of the biodegradable plastic composite and about 30 wt. % or less of the hemp fiber with respect to a weight of the biodegradable plastic composite.

15. A method of producing a biodegradable composite comprising:
wetting a bio-derived fiber with an wax emulsion including a bio-derived wax, to infuse the bio-derived fiber with the bio-derived wax to have a surface energy of about 45 mJ/m²-about 50 mJ/m²; and
fusing the bio-derived fiber infused with the bio-derived wax with a biodegradable plastic polymer having a biodegradability of from about 80 to 95 percent (%) within 180 days, when measured according to a biodegradability test in accordance with an ASTM D6400-19 standard, wherein
a polymeric matrix of the biodegradable plastic polymer has a tensile strength of about 30 MPa to about 45 MPa and an elastic modulus of from about 2600 MPa to about 3600 MPa, and
the bio-derived fiber has:
an average diameter of from about 20 microns to about 30 microns,
an average length of from about 15 mm to about 20 mm, and
a tensile strength greater than the tensile strength of the polymeric matrix of the biodegradable plastic polymer and an elastic modulus greater than the elastic modulus of the polymeric matrix.
